(19) United States
(12) Patent Application Publication
(10) Pub. No.: US 2026/0338526 A1
(43) Pub. Date: Oct. 29, 2026

(54) Communicable Linear Measurement Device with Precision

(71) Applicant: CLICKZY CREATIVE TECHNOLOGIES PRIVATE LIMITED, Kota (IN)

(72) Inventors: Jitender Singh, Kota (IN); Krupal Variya, Kota (IN)

(21) Appl. No.: 19/257,868

(22) PCT Filed: Apr. 8, 2024
(86) PCT No.: PCT/IN2024/050363

§ 371 Date: Jun. 25, 2026

(30) Foreign Application Priority Data
Apr. 17, 2023 (IN) 202311027881

(51) Int. Cl. G01B 3/30; G01B 3/1005; G01B 3/1069; G01B 5/02; G01B 5/24

(52) U.S. Cl. CPC G01B 3/30; G01B 3/1005; G01B 3/1069; G01B 5/02; G01B 5/24; G01B 2003/103

(57) ABSTRACT

A linear measurement device (100) comprising a printed circuit assembly (180) having a plurality of navigation buttons (200), a display (155), a computer program residing in a micro-controller, the printed circuit assembly (180) disposed in a cover (160), a casing (110) having an integrated bobbin shaft (120) 5 and a rim (119), a measuring strip (102), the linear measuring device (100) measures a linear dimension in a first measurement manner and in a second measurement manner, wherein, the first measurement manner is a linear measurement and the second measurement means is an angular measurement, the linear measurement device (100) is configured to display and communicate a 10 linear measure by the fist measurement manner between any two markers and an angular measure by the second measurement manner between every two markers, the linear measurement device (100) is configured for a 2-way communication and configurable to form a group mesh.

### CLAIM OF PRIORITY

The present patent application takes priority from Indian Patent Application Number 202311027881 filed on 17 Apr. 2023, titled “Communicable Linear Measurement Device with Precision”.

### FIELD OF THE INVENTION

The present invention relates to a linear measurement device. Particularly, the invention relates to a communicable linear measurement device. More particularly, the invention is a high precision and communicable linear measurement device.

### BACKGROUND OF THE INVENTION

Length measurement is probably the most common and data intensive measurement. Measuring tapes are a common gadget for professionals dealing in few millimeters to several meters. Use of conventional measuring tapes results in near infinite numerical data, which has associated challenges to be organized and analyzed to be deployed effectively.

There have been earlier attempts to automate and digitize the measuring tape. Illustratively, U.S. Pat. No. 4,551,847 discloses a digital measuring device which is motorized.

KR1020200131631 discusses a smart tape measure and comprises an LED display panel operation unit for operating an LED display panel, a display panel confirmation operation button, and an LED display panel cancellation operation denial DEL button. The LED display panel is a display panel that displays the measured length to a decimal place, and the LED display panel is an LED display panel that displays a function of storing the length of the tape measure and a unit conversion function. A magnet support plate capable of easily and reliably fixing to an object to be measured is attached. An air adsorption plate for fixing an additional tape measure is attached to the tape measure part. A magnet ring for fixing a tape measure is used with the air adsorption plate. At this time, the degree of movement of the tape measure is measured by using a photo sensor formed in the tape measure and is displayed on the LED display panel. A length value is stored. A previous measurement value can be checked through the LED display panel.

US 2004/0040170 A1 discloses a digital tape measure includes a housing containing a measuring line, a rotatable measuring drum in engagement with the measuring line so that movement of the measuring line causes rotation of the measuring drum, and a rotatable disc coupled with the measuring drum for rotating simultaneously with the measuring drum. The digital tape measure includes an optical Sensor in communication with the rotatable disk for compiling data related to rotation of the disk, and electronic circuitry in communication with the optical sensor for processing the compiled data So as to calculate a length of the measuring line drawn from the housing.

U.S. Pat. No. 11,092,417 B1 discloses a digital workpiece measurement system and method for intelligent measurements measures the length, angles, and characteristics of a workpiece, and then automatically displays the measurement and the other identifying measurement related data in a digital, incrementally adjustable manner. The workpiece measurement system provides a flexible measuring tape and micro meter head that electronically measures the distance between a starting measuring point and an ending measuring point. The short point, long point, square cut angle, and characteristics of the workpiece are inputted into the system.

U.S. Pat. No. 11,199,391 B2 discloses a digital measuring tape that includes a shell body, a tape, and a tape spool. A coiling shaft is provided inside the shell body. The tape spool is installed on the coiling shaft for rotating with respect to the coiling shaft. The tape is coiled around the tape spool, and a front end of the tape is provided with a hook. The digital measuring tape further includes a grid dial, a grid detector, a circuit board, and a display screen. The grid dial is fixed on the tape spool for rotating. A circumferential edge of the grid dial is provided with a plurality of grids. Rotation of the grid dial and the grids enables the grid detector to produce a detecting signal of rotation of the grid dial. With the detecting signal, a length of the pulled tape is calculated through the circuit board, and displayed on the display screen.

U.S. Pat. No. 11,460,284 discloses a digital linear measuring wherein the user can decide when to save a measurement, at which point the saved measurement will appear on a secondary screen (either a portion of the primary display, or a secondary adjacent display) as a previously taken measurement. These measurements can account for both an external measurement read from the tape measure, as well as an internal measurement, and the measurement may be adjusted where necessary to take into consideration the length of the device body.

Interior designers, architects, garment industry, to name a few, deal with huge measurement data which if captured with higher precision and processed with ease can upskill such industrial application to a higher degree of efficiency and quality, which the present invention facilitates.

### OBJECT OF THE INVENTION

To invent a length measurement device which has high intrinsic precise measurement capability.

To invent the length measurement device which has redundant measurement capability.

To invent the length measurement device which can receive and send measurement data in real time.

To invent the length measurement device which is calibratable/self-calibratable to offset manufacturing and aging variations.

To invent the length measurement device which is capable of sending and receiving audio information and instructions.

To invent the length measurement device which is capable of receiving visual information and instructions.

To invent the length measurement device which is capable of validating measurements automatically by referencing from pre-decided specification.

To invent the versatile digital length measurement device configurable for various industries including garment industry, fitness industry, construction and interiors industry, event industry etc.

To invent the robust digital measurement device suitable for functioning in industrial environment with dust, vermin, moisture.

To invent the length measurement device with redundant network communication capability.

### SUMMARY OF INVENTION

The present invention is an intelligent linear measurement device that measures a linear dimension in at least two human independent manners.

A first measurement manner is a direct manner wherein the direct manner is a linear measurement of an-unrolled segment of the measuring strip. A preferred embodiment of the first measurement manner comprises a continuous linear grid pattern consisting of dark zones and clear zones which are repeatedly printed on a rear side of the measuring strip in the direction of unrolling. An 8-bit photodetector disposed opposite the rear side of the measuring strip is configured to send and receive an orthogonally linear beam of light, implying that the beam of light is orthogonal to a direction of linear movement of the measuring strip, while the linear beam cuts across a full width of the measuring strip. The optical encoder interprets the continuous linear grid patterns. The continuous linear grid pattern does NOT correspond to the conventional binary code. Importantly, the continuous linear grid pattern is a form of binary that uses a different method of incrementing from one number to the next such that only one bit changes from one position to another. This feature allows a system designer to perform some error checking, i.e., if more than one bit changes, the data is apprehended to be incorrect. The photodetector detects a start of the continuous linear grid pattern of all clear blocks to ascertain a home position of the measuring strip. The 8-bit photodetector provides a resolution of 2\hat{ }8 measurement points.

A second measurement manner is an indirect manner wherein the indirect manner is an angular measurement of a rolled segment of the measuring strip. The indirect measurement may be carried out magnetically or optically or by a combination thereof. The preferred embodiment of the present invention is provided with a plurality of hall effect sensors, which is a type of magnetic sensor which can be used for detecting a rotation of a diametric magnet by sensing strength and direction of a moving magnetic field produced from the diametric magnet. The diametric magnet here denotes a thin circular magnet having its North and South pole situated diametrically opposite, at its circumferential periphery. The diametric magnet is firmly disposed on a bobbin residing in the casing. The bobbin and the magnet are co-axial with the axis of the casing. A plurality of Hall Effect sensors reside in a sensor chip which is disposed along with a proprietary electronic hardware assembled on a printed circuit assembly. The printed circuit assembly and the diametric magnet are relatively disposed such that the hall effect sensors are maintained at a prescribed gap with respect to the diametric magnet, while freely rotating with the bobbin. In the preferred embodiment, the relative placement of the diametric magnet and the plurality of hall effect sensors is non-coplanar and axial. As a variation, it could be co-planer and axial.

When the measuring strip is pulled out or retracted back, the bobbin rotates and this leads to an angular rotation of the diametric magnet. In the preferred embodiment, the sensor chip packaging a plurality of Hall Effect Sensors is capable to detect and communicate a resolution of 4096 in one full rotation of the diametric magnet, which implies an angular resolution of 360/4096=0.0878 degrees or 5.27 minutes, or approximately 6 minutes or one tenth of a degree measure.

A preferred embodiment of the present invention is configured to display and communicate a linear measurement as measured by the fist measurement manner and which is a direct or a linear measure, wherein between any two linear measurements, a finer resolution detectible by the second measurement manner is used to display and communicate a precise measure up to 0.05 mm. The second measurement manner is thus deployed analogous to a “vernier” scale of commonly known vernier callipers. It is therefore appreciable that the linear measurement device as per present invention is comparable to a vernier calliper, known for their precision!

As a variation, the present invention is provided to display and communicate only with a first measurement manner or only with a second measurement manner.

Measurements by the first measurement manner and the second measurement manner are compared periodically and corrected/calibrated for coarse and fine correction as per application.

The first measurement manner which is the direct manner is also an absolute measurement manner since it is configurable irrespective of a reference point like zero position etc., since a home position is permanently stored. Consequently, in the event of a power failure or interruption followed by resumption the measurement device reads and communicates error-free measurement as each reading is an absolute value, quite like a conventional printed measuring roll, and there is a specific digital signal associated with every position.

In the embodiment with only a second measurement method, a home position is inputted once, for each session of measurement by rolling in the measurement strip completely.

The linear measurement device as per present invention is communication capable. Measurements being carried out are directly radio communicated to a target file as the user presses a button present on the device on completion of each measurement. Such measurements may be stored on the measurement device or communicated in real time, or both.

The communicable linear measurement device as per the present invention offers a huge technical advance in bulk measurements particularly in manufacturing and inspection of products with linear measurements. One such application is in garment manufacture, and following description is based on such manufacture. However, the communicable device is not restricted thereto.

Products are generally measured against a specification which has multiple points of measure. Product of each size and version has different measurement and different corresponding specification. Products are checked against these specifications at different stages of production. Generally, specification formats are modified as per the stage of production/inspection as convenient to the factory production and quality team. Such changes include but are not limited to a checker identification number, a style name/number, ordering of point of measures for better speed and lower material handling, date, line, error highlighting, final result of pass or fail, statistical quality control parameters like AQL etc. The present invention addresses such needs in a 2-way communication. The linear measurement device as per present invention is equipped with communication capability from and to server through a WIFI router or directly through Bluetooth, or through any state-of-the-art communication capability.

The communicable linear measurement device is started or is woken up from deep sleep state by pressing a start button configuration to commence an initialization, whereby the device, in its preferred embodiment, sets up a base code previously resident in a micro-controller in the printed circuit assembly, activates configuration files, Bluetooth low energy (BLE) keyboard including button configuration, magnetic sensor configuration; and a user interface is loaded. This makes the device usable communicably. After a user authentication, the device is usable by pressing a measurement button configuration to display or send each measurement. Each measurement is organized and sorted according to a fetched format received and is stored at a prescribed field location in a server. In this 2-way communication process, each and every data generated by a linear measurement is an organized data ready for analysis by server.

A connected server can send data/instructions/suggestions to the measurement device. The measurement devices can also send data/instructions/suggestions to the server. This innocent looking 2-way communication in between device and server and this functionality is used to capture, implement and achieve many process improvements, which otherwise get lost in manufacturing routines.

The 2-way communication in the present invention is not limited to sending and receiving text only. A camera provided in the device facilitates scanning a code including a QR code, a bar code, to fetch a corresponding specification. The camera facilitates visual capturing, recording and communicating of a defect or anomaly. The 2-way communication includes a voice to text communication to server and a text to voice communication to the device, through a microphone and a speaker disposed on the back of the printed circuit assembly of the device.

In a manufacturing ambience, there are generally multiple measuring devices present. Not all the devices may by present in an adequately strong connectivity signal at all times, due to distance from WIFI routers, obstructions and or user moving around, resulting in one or more devices intermittently or repeatedly transitioned into an offline mode. The present invention addresses such common industrial situation in an inventive and redundant way. The communicable device buffers a measurement data in low or no connectivity instance and send/receive continues seamlessly as the network connectivity restores. The device auto shuts when it nears end of power to a prescribed low level.

Importantly, each device is equipped with a routing functionality and presence of any other device is effectively equivalent to a router in vicinity. In other words, in a factory ambience with a dense population of the communicable device, a burden on router placement significantly reduces while a robust data management seamlessly and silently delivers required data and specification. A group mesh formation of devices with a device identification number associated with each data string comes into effect. The mesh formation reduces network investment wherein data including specification hops from one device to the other or directly to the router and a combination thereof, while at the same time the data remains clearly identified and segregated specific to identification provided. A plurality of measuring devices within a prescribed distance can send or receive data and attach an address. Formation of group mesh formation, addition of a device is configured only at the server level via a supervisory configuration control and the server communicates device identification to all the devices in an identified group.

The group mesh formation of devices provides insulation between different group mesh formations, which is a practical reality causing nuisance of data leakage in a cramped manufacturing complex of different firms.

Deployment of routing functionality in each measurement device is yet unexplored in industrial ambience of mass manufacture, particularly in a non-continuous line of manufacture which the present invention effectively does which minimises data loss and opens avenues of building artificial intelligence around such organized data, collectible with minimal efforts.

The communicable linear measurement device is configurable to operate independent of the server software in an “individual” mode, wherein the device is either paired with a laptop/mobile or used without pairing. In the preferred embodiment, the device is discoverable on laptops/mobiles as a Bluetooth device. Once the connection is established by clicking on the pair/connect option, the device works like a Bluetooth keyboard, wherein the data sent by the device is sent to an active application on the laptop screen, like any connected keyboard would send. The active application could be any contemporary application including excel/other spreadsheet, text file or any custom QM/PLM software. Illustratively, the data sent by the device configured as “individual” is captured in Excel sheet at a pre-decided location/field. Further, the user has an option to use the navigation buttons disposed on the device for navigating in the paired excel sheet/spreadsheet.

Such networked two-way communication capability creates possibilities to manage the growing complex and interdependent communication in between the device and the server, consequent to the new opportunities of analyses and deployment created by the present invention, as unlimitedly multiple such independent communications would possibly be happening simultaneously for all devices together.

Further, this data is now available in real time and analyses of this data would be obtainable in real time. This arrangement could lead to further foreseeable actions by the server like blocking a device or sending warning signals to devices etc. Parallelly this analysis enables the managers related to the factory shop floor to take quick action anywhere anytime which could result into huge reduction in cost of poor quality by nipping the problem in the bud itself.

To strike a balance between quality and productivity, a number of supervisory configurable controls are incorporated. Illustratively, a supervisory configurable control permits a measurement to be skipped if it is not tagged as compulsory, or a measurement is permitted to be taken at a prescribed frequency, like hourly, or after a prescribed number of measures, or for a prescribed number of measures. On the other hand, a compulsory measure cannot be skipped by a user. If there are any compulsory measurements and have not yet been recorded, the system does not allow to go to the next garment, instead showing the unskippable measurements as highlighted which are still blank.

A dimensional tolerance is relaxable by a supervisory configurable control. A previously prescribed dimensional tolerance is displayed on the measurement device for respective measurement. If a reading taken is out of prescribed tolerance band, the measurement device prompts to confirm or retake the measurement. If the user confirms, it may imply that the particular object to be segregated.

The supervisory configurable controls are exercised through a server software and or through a supervisory measurement device, which in turn is such authorized through the server software. The supervisory configurable control is dynamically controllable to be effective cyclically or at a set time or device wise, as assessed by the manager and or as per the need on the shop floor.

The measurement device as per present invention has a plurality of navigation buttons and a display as a user interface with the computer program residing in the measurement device.

The measurement device as per present invention may be equipped with a laser line to facilitate precise references of measurement when used for conventional or manual measurement activities.

The measurement device may be calibrated by the computer program residing in the measurement device. The measurement device may be manually calibrated as well.

The measurement device as per the present invention is prudently organized in and around the casing for all mechanical components. The casing comprises an integrated bobbin shaft, manufactured and produced by injection molding. Consequently, the bobbin shaft is orthogonal to a base of the casing with the precision of machining of the injection mold which is of the order of thousandth of a millimeter. The casing has a rim of a low height collar of typically less than a millimeter and a low width of less than a millimeter. The rim ensures a minimum frictional force comes into play when the bobbin rotates. In absence of such a rim an entire circular surface would be rubbing against the base of the casing causing excessive frictional force to be then countered by a spring of relatively higher force, thus lesser life!

The bobbin shaft is a hollow, comprising a minimum diameter cylinder and a maximum diameter cylinder for a restricted circumference and a restricted height, consequently resulting into a stepped cylinder and a plurality of seats. A slit divides the bobbin shaft into two halves, while the stepped cylinder also is bifurcated into two halves, which reversibly collapse inwards on application of an external inward force F on both sides. A bobbin houses a torsion coil spring in an inside and wraps a measuring strip on an outside, has a bobbin slot, and a mounting provision for disposing a magnet holder which also acts as a spring cover. The mounting provision could be a plurality of recesses. The magnet holder has a plurality of mounting projections corresponding to the plurality of recesses in the bobbin, a stepped hollow cylinder wherein a large inner hollow cylinder houses the slim diametric magnet which is interference fit, while a small inner hollow cylinder interferingly captures the two halves of the stepped cylinder, while the magnet holder is pressed into its mounting provision in the bobbin, resulting into the inward force F on the two halves of the stepped cylinder. Simultaneously the magnet holder also rests on the seat of the bobbin shaft. Such a construction minimizes axial play (up-down) and angular wobble. The torsion coil spring has an outer end, which is engaged in a bobbin slot, while and inner end is trapped in the slit of the bobbin shaft. A stabilizer having a collar and a fence is disposed between a printed circuit assembly and the bobbin which is particularly holding the diametric magnet having a conducting surface, the stabilizer functioning as a mechanical compactor and an electrical insulator. The collar engulfs the stepped hollow cylinder of the magnet holder, while pressing the magnet holder, further pre emptying possibility of wobble.

A device cover with a plurality of peripheral projections fits onto a complementary plurality of peripheral receptacles of the casing. The peripheral projections would not reach/engage with the complementary peripheral receptacles if there is any undue gap between the printed circuit assembly and the stabilizer.

As a variation, the device cover could be with a plurality of peripheral receptacles that capture a complementary plurality of peripheral projections of the casing. The reverse arrangement would likewise engage if there is any undue gap between the printed circuit assembly and the stabilizer.

The projections and the corresponding receptacle are combinations of equal or unequal dimension and shapes different peripheral locations on casing and device cover.

Such an assembly with the stabilizer has an engineered constraint in the axial direction of the axis to ensure minimal operational play axially as well as angularly around a root of the bobbin shaft. A consciously reduced surface contact between the casing and a bottom surface of the bobbin via the rim, between the bobbin shaft and casing on a lower side, and between the bobbin shaft and the magnet holder on an upper side ensures minimal operation friction, thus rolling/unrolling force and wear.

A wobble of the bobbin may apparently measure an excessive measure as shown by a solid line for a corresponding true length as shown by a dotted line. In the present invention, importantly, the first measurement manner which is the linear measurement of the unrolled segment of the measuring strip, is immune to a wobble of the bobbin since an 8-bit optical encoding provides a wobble-independent measure at every 0.6 cm (150 cm/2\hat{ }8), Consequently, a wobble is restricted to cause error in between these intervals ONLY as after every optical reading the previous error is reset and prevented from accumulating. Within this interval of 0.6 cm, the angular measurement of the un-rolled segment of the measuring strip gives a resolution of 0.005 cm. Even at an error of 10%, which is highly unlikely given the engineering constraint as explained above, this will 0.0005×0.6=0.0003 cm error, which also is predictable and adjusted in calibration mode.

A slender passage is created in the casing having a width and a height marginally higher than the width and the height of the measuring strip, with a relatively much longer length, of the order of 2 cm to 6 cm or more. The slender passage arrests wavy strip entering the slender passage due to a force of the torsion spring which constantly keeps the measuring strip under a tendency to be pulled and rolled on the bobbin. Arresting the waviness by letting them “die” in the slender passage is a prudent and inventive aspect of controlling undesired air from entering while the measuring strip is allowed to roll back freely, and consequently checking and controlling unnecessary air getting trapped in-between different layers of rolled strip and avoid error due to diametric variation in magnetic measurement.

Another source of inter-layer air gap related variation is aging due to use and consequent reduction in pull force of the aged spring. As per the present invention, once a predefined number of cycles of rolling and unrolling of measuring strip are counted by the computer program, the device displays and suggests to replace a measuring strip assembly.

The present invention is conducive to such a replacement by user, wherein the measuring strip assembly comprises a casing housing the bobbin with the magnet holder, torsion spring, diametric magnet, stabilizer and the measuring strip.

The measurement device is calibrate-able. Also, the measurement device as per the present invention performs an inbuilt automatic calibration at regular intervals based on a pre-set count of winding/unwinding cycles, prudently exploiting the inventive dual encoding feature of the present invention. Such automatic self-calibration is directly relatable to predictable as well as unpredictable wear and tear and the correction consequently necessitated. Particularly, a variation in an effective thickness (implying a material thickness and an inter-turn gap) and length of the measuring strip with reference to a prescribed corresponding initial value consequent to use, aging and or environmental effect and with reference to a relatively non-wearing references including a base diameter of the bobbin on which the measuring tape commences rolling is calculated in accordance with the first measure and the second measure statistics generated in the linear measurement device and compensated depending on application. The automatic self-calibration assumes significance particularly if a defect like unusual variation in effective thickness due to contamination, or a tear or a fragmentation of the measuring strip happens, which otherwise would impact quality of measurement between two widely instances of planned calibrations!

The measurement device as per the present invention is prudently organized in and around casing for all mechanical components, and in and around the cover for all electrical & electronic components. This inventive segregation facilitates short length of pluggable connections, mutually as well as exclusively enhances precision AS WELL AS robustness of the device.

The printed circuit assembly is disposed in the device cover and all associated electrical parts are correspondingly laid out, as described below. A camera, previously described, is disposed on a back of the of the printed circuit assembly, peeps out of an opening provided in the cover. A versatile 5-button navigation keypad sits on an outside of the cover through a keypad slot provided. The keypad is disposed on the back of the printed circuit board and projects out of the cover at an agronomical location particularly for a right hand person, aiding to quick actions and productivity. A memory card receptacle is provided through which a contemporary external memory card is insertable, such that the external memory card connects to the printed circuit assembly directly. The external memory card stores measurement data during unscheduled or temporary disconnections with the server. Also, in case of the measurement device being used in an offline mode, all measurement data is stored in this external memory card.

A charging receptacle is provided in the cover, through which a charging pad pops out of the measuring device to be able to mate with a charging pin correspondingly disposed in a complementing charging dock.

The cover of measurement device has a USB port receptacle through which a USB port disposed on the printed circuit assembly is accessible to upload and download data, besides charging.

A display cum battery receptacle is disposed on the cover. The display cum battery receptacle receives a 1000 mAh to 2000 mAhr battery in a socket. A battery cover plugs into an opening of the receptacle. A display panel is disposed on a top face of the receptacle. Connecting wires from the battery as well as the display panel are routed to the printed circuit assembly through a plurality of guides provided in the display cum battery receptacle. The battery capacity is primarily limited by size of batteries and not necessarily by parts and components of the electronic circuitry.

The measurement device as per the present invention, consequent to being provided with a 2-way communicable capability can cater to newer industrial needs, without ignoring conventional needs. Many times, situations arise when some ad hoc inspection is required to be done, but no specification chart for inspections is available. With our 2-way communication enabled device this becomes like any other regular inspection. There is an option to start an ad-hoc inspection and this could be initiated in a blank document where the format is built as the user starts creating and measuring points of measure. Or this could be started in a pre-built template which is like a skeleton format of the most common points of measure specific to a certain type of designs like shirts, trousers, blouses etc. This is categorised under user defined styles in the server in folder configuration. Different styles are like different folders under the broad category of user defined Styles.

The present invention of linear measurement device, which may appear an improvised “measuring tape” at the first instance, is actually a huge technical advance of intelligently exploiting the mundane data to an organized one. The present invention is an ergonomic and improvised system of devices functioning dependently to meet the objective of economic significance of productivity improvement, quality upgradation, thereby reducing product waste and cost.

### DESCRIPTION OF DRAWINGS

FIG. 1 is a perspective view of a linear measurement device and its complementing charging dock as per present invention.

FIG. 2 is an exploded view of the linear measurement device including the charging dock.

FIG. 3 is a representative view of a linear measurement and an angular measurement.

FIG. 4 is a representative view of an optical measurement arrangement.

FIG. 5A-5D are representative views of continuous grid pattern with continuous light beam at different instances of linear measurement.

FIG. 6 is a perspective view of a measuring strip over a photodetector.

FIG. 7 is a top view of the measuring strip over the photodetector.

FIG. 8 is a tabulation of clear and dark zones and their interpretation.

FIG. 9 is a tabulation of conventional binary values of illustrative numeric values and corresponding conversion formulae.

FIGS. 10A and 10B are representative top view and front view respectively of positioning of a magnet with respect to hall sensors.

FIG. 11 is an exploded view of the charging dock to show axial positioning of magnet and hall sensor on a bobbin carrying the measuring strip in a casing.

FIG. 12 is a partial front view showing angular movement of the diametric magnet in the liner measurement device.

FIG. 13 is a front view of the measuring strip rolled on the bobbin.

FIG. 14 is a representative view of 2-way communication of the linear measurement device.

FIGS. 15A-15F are operational flow diagrams of the linear measurement device.

FIG. 16 is a front view of the linear measurement device.

FIG. 17 is a representative view of code reading by the linear measurement device.

FIG. 18 is a representative view of camera deployment on the linear measurement device.

FIG. 19 is a representative view of 2-way audio communication by a plurality of the linear measurement devices.

FIG. 20 is a representative view of a mesh group formation of the linear measurement devices.

FIG. 21 is a representative view of the linear measurement device in an individual mode.

FIGS. 22-24 are operational screen views of display of the linear measurement device.

FIG. 25 is a sectional view of mechanical assembly of related components.

FIG. 25A is a perspective view of the casing with a magnified construction.

FIG. 26 is a perspective view of a bobbin shaft of the casing.

FIG. 27 is a perspective view of the bobbin.

FIG. 28 is a perspective view of a magnet holder.

FIG. 29 is a perspective view of fitment of the bobbin shaft in the magnet holder.

FIG. 30 is a perspective view of a torsion coil spring of the linear measurement device.

FIG. 31 is a perspective view of a stabilizer.

FIG. 32 is a perspective view of the casing and the cover in an assemble-able orientation.

FIG. 33 is an exploded view illustrating an axially constrain.

FIG. 33A shows an unrolled measuring strip with a wobble of a bobbin and corresponding strip lengths.

FIG. 34 is a front view of a slender passage in the casing and a representative cross-section thereof.

FIG. 35 is a screen shot displaying a replacement prompt by the linear measurement device.

FIG. 36 is an exploded view of a replaceable measuring strip assembly.

FIGS. 37A, 37B are operational screen views of the display.

FIGS. 38A, 38B are perspective views of the device cover.

FIG. 39 is a perspective view of the linear measurement device with an external memory card.

FIG. 40 is a perspective view of the linear measurement device with charging pins of the complementing charging dock.

FIG. 41 is a perspective view of the complementing charging dock.

FIG. 42 is a perspective view of a display cum battery receptacle.

FIG. 43 is an exploded view of a battery and battery cover along with the linear measurement device.

FIGS. 44-50 are operational screen views.

### DETAILED DESCRIPTION OF THE INVENTION

The present invention shall now be described with the help of drawings. There are innumerable variations possible around the inventive concept of the present invention and the description should not be construed to limit the invention in any manner whatsoever.

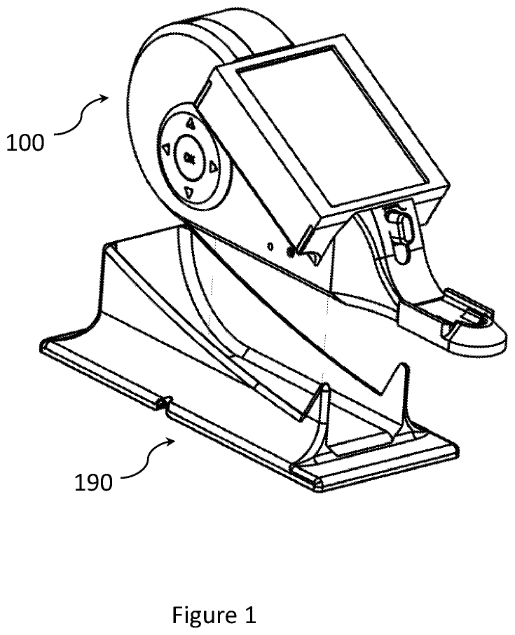

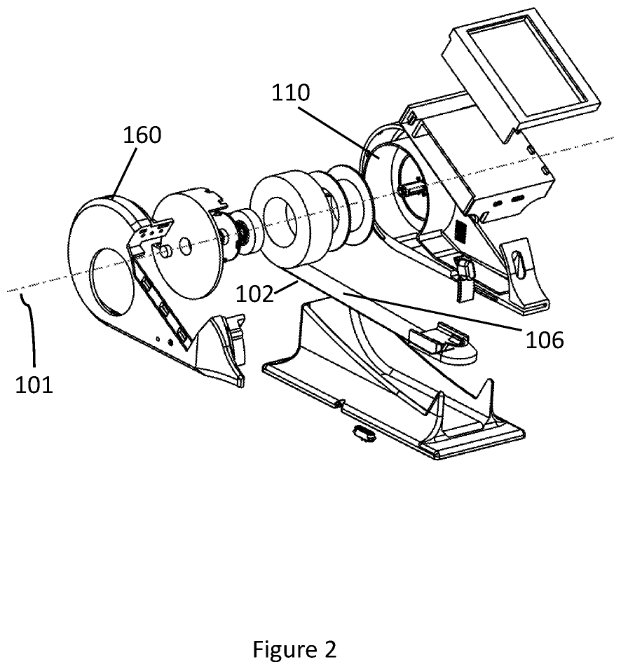

FIGS. 1, 2, the present invention is an intelligent linear measurement device (100) with a measuring strip (102) that is rolled and unrolled around an axis (101) of a casing (110). The measuring strip (102) has a conventional measurement markings (not shown) on a front side (106) to facilitate use as an all familiar measuring tape, reading a measurement value by eye.

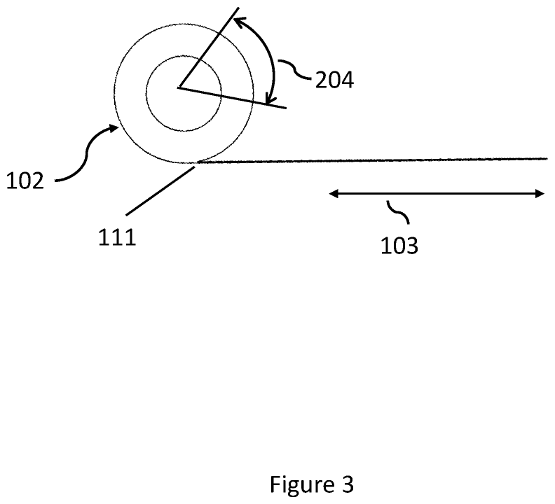

FIG. 3, the intelligent linear measuring device (100) as per the present invention measures a linear dimension in at least two human independent manners.

A first measurement manner is a direct manner wherein the direct manner is a linear measurement (103) of an-unrolled segment of the measuring strip (102).

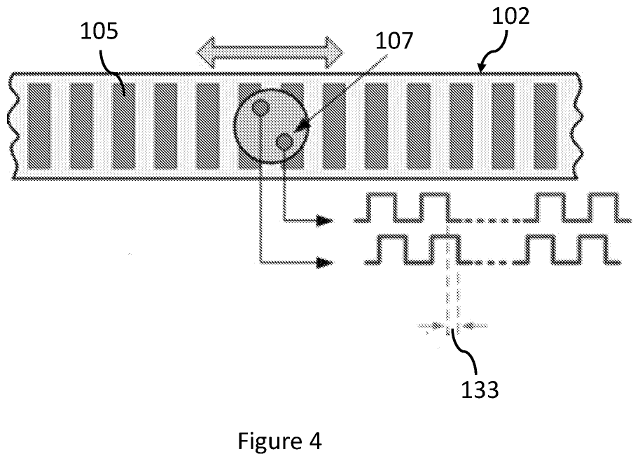

FIG. 4, a preferred side of the measuring strip (102) is provided with a plurality of equidistant markers (105) of identical width. Such markers are detected by a detecting means (107) stationed in a referenced position, illustratively in the casing (110). The markers and detecting means are a magnetic, optical, electric and or a combination thereof. Thus, an optical to electric transducer generates an electric pulse proportional to a width and a distance between the markers which is direct function of a linear measurement. Typically, such linear measurement arrangements deploy a pair of detectors, to be able to generate a relative difference (133) between two signals and detect a linear direction of motion, and thus provide a linear measurement in an absolute manner, and or in an increasing as well as a decreasing value of measure.

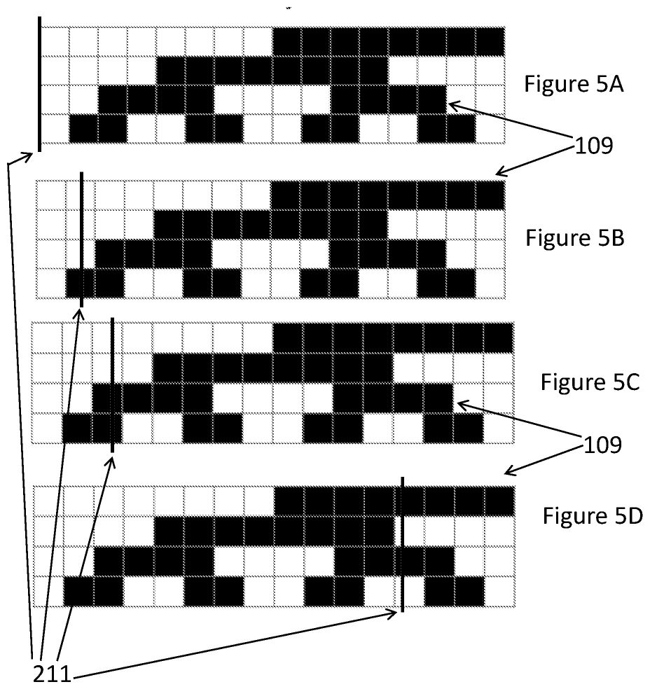

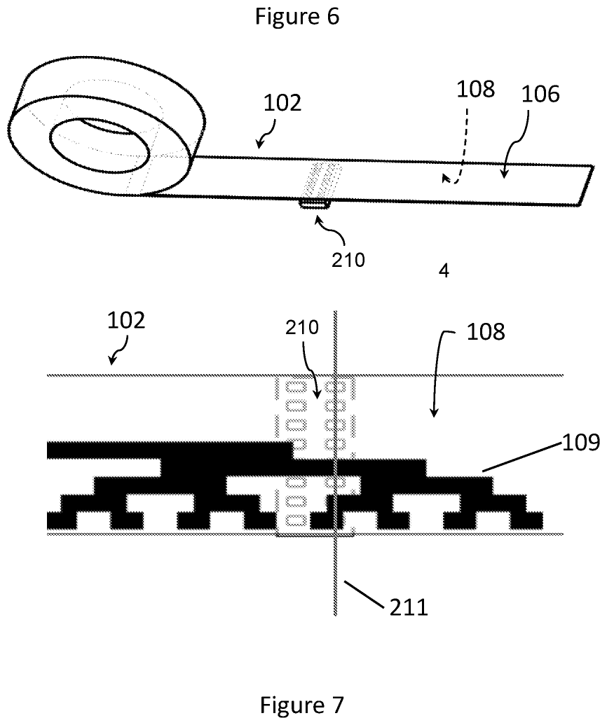

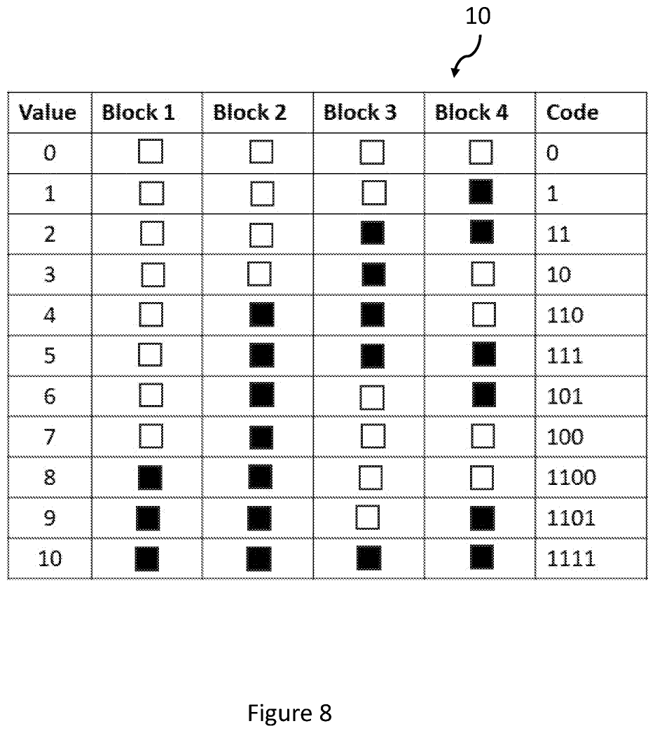

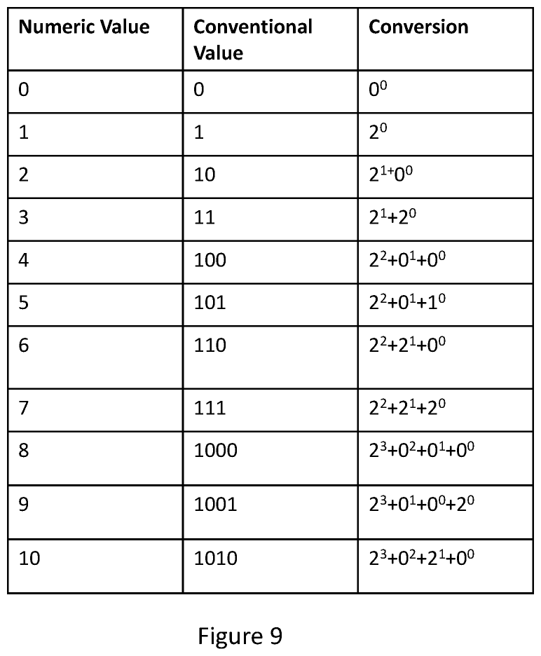

FIG. 5A-5D, 6, 7, a preferred embodiment of the first measurement manner comprises a continuous linear grid pattern (109) consisting of a plurality of rows of dark zones and clear zones which are repeatedly printed on a rear side (108) of the measuring strip (102) in the direction of unrolling. An 8-bit photodetector (210), as shown in FIG. 7, disposed opposite the rear side (108) of the measuring strip (102) is configured to send and receive an orthogonally linear beam of light (211), implying that the beam of light is orthogonal to a direction of linear movement of the measuring strip (102), while the linear beam (211) cuts across a full width of the measuring strip (102). The optical encoder interprets the continuous linear grid patterns as co-relatably tabulated in FIG. 8. Thus, the optical encoder is configured to read “2” when the linear beam of light detects 2 clear blocks followed by two dark blocks, corresponding to a code 0011, and reads 3 when the linear beam of light detects two clear blocks followed by one dark block and one clear block, corresponding to a code 0010. Noteworthy that in a conventional binary code, FIG. 9, numeric 2 and 3 is represented by an exactly opposite binary code, that is 10 and 11 respectively. In other words, the continuous linear grid pattern does NOT correspond to the conventional binary code shown in FIG. 9 and importantly the continuous linear grid pattern is a form of binary that uses a different method of incrementing from one number to the next such that only one bit changes from one position to another. This feature allows a system designer to perform some error checking, i.e., if more than one bit changes, the data is apprehended to be incorrect.

The photodetector (210) detects a start of the continuous linear grid pattern of all clear blocks, FIG. 9, to ascertain a home position of the measuring strip (102). The 8-bit photodetector provides a resolution of 2\hat{ }8 measurement points.

For a tape length of 150 cm we obtain a resolution of 1500/2\hat{ }8=5.8 mm.

A second measurement manner is an indirect manner wherein the indirect manner is an angular measurement (204), FIG. 3, of a rolled segment of the measuring strip (102). The indirect measurement may be carried out magnetically or optically or by a combination thereof.

In an optical arrangement, the casing (110) is provided with a plurality of equidistant optical markers of identical width. Such markers are provided in a circle and are detected by a rotating optical detecting means stationed axially in the casing (110) such that such circularly provided markers are in sight of the optical detecting means.

Magnetic encoders are a type of rotary encoder that use sensors to identify changes in magnetic fields from a rotating magnetised bar, wheel or ring.

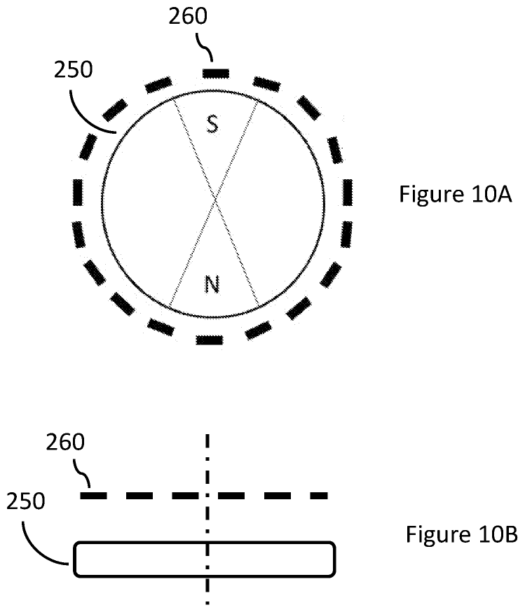

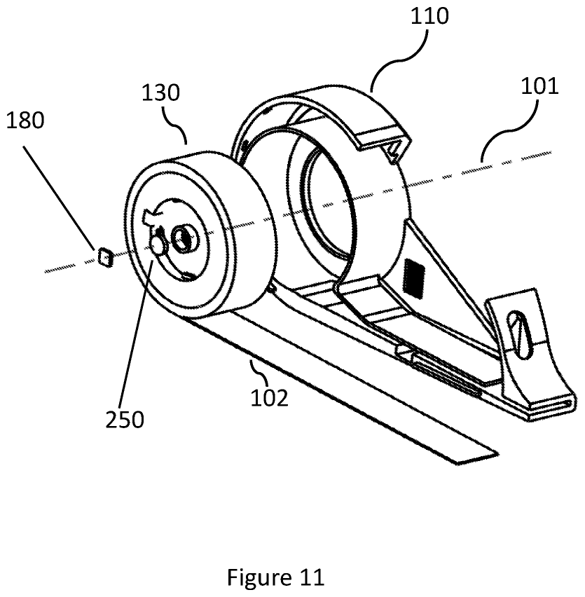

FIGS. 10A and 10B, the preferred embodiment of the present invention is provided with a plurality of hall effect sensors (260), which is a type of magnetic sensor which can be used for detecting a rotation of a diametric magnet (250) by sensing strength and direction of a moving magnetic field produced from the diametric magnet (250). The diametric magnet (250) here denotes a thin circular magnet having its North and South pole situated diametrically opposite, at its circumferential periphery.

FIG. 11, the diametric magnet (250) is firmly disposed on a bobbin (130) residing in the casing (110). The bobbin (130) and the magnet (250) are co-axial with the axis (101) of the casing (110). A plurality of Hall Effect sensors (260) reside in a sensor chip which is disposed along with a proprietary electronic hardware assembled on a printed circuit assembly (180). The printed circuit assembly (180) and the diametric magnet (250) are relatively disposed such that the hall effect sensors (260) are maintained at a prescribed gap with respect to the diametric magnet (250), while freely rotating with the bobbin (130). FIGS. 10A and 10B, in the preferred embodiment, the relative placement of the diametric magnet (250) and the plurality of hall effect sensors (260) is non-coplanar and axial. As a variation, it could be co-planer and axial.

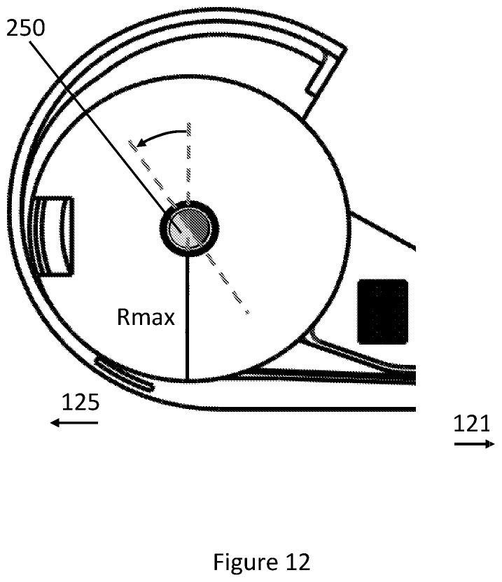

FIG. 12, when the measuring strip (102) is pulled out or retracted back, the bobbin (130) rotates and this leads to an angular rotation of the diametric magnet (250). In the preferred embodiment, the sensor chip packaging a plurality of Hall Effect Sensors (260) is capable to detect and communicate a resolution of 4096 in one full rotation of the diametric magnet (250), which implies an angular resolution of 360/4096=0.0878 degrees or 5.27 minutes, or approximately 6 minutes or one tenth of a degree measure. At a point of transition (111), as shown in FIG. 3, where the measuring strip (102) is straight on a user side (121) and spiral on a parking side (126), a radius Rmax of the wound measuring strip (102) is considered to arrive at a linear resolution of the second measurement manner to be 2×π×Rmax/4096=0.046 mm or approximately 0.05 mm, for a value of Rmax=30 mm,

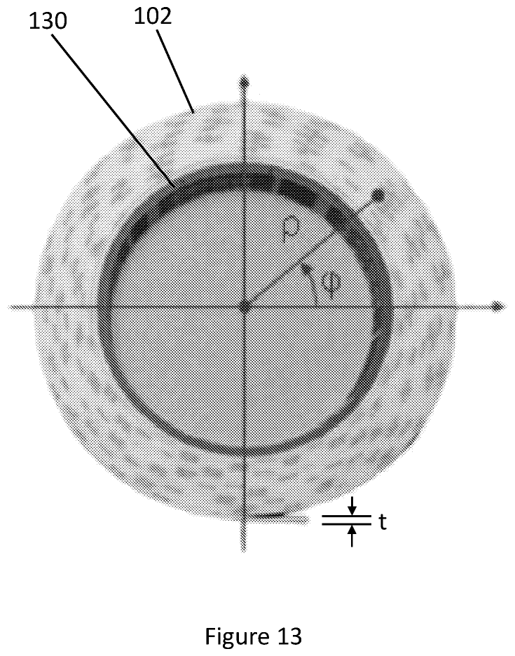

FIG. 13, as a variation, the linear measure L is obtained by deploying a continuously varying radius of the measuring strip (102) by using a known measurement algorithm

L(φ₁, φ₂)=t/2π(∫\sqrt{(φ²+1)}dφ
integrated over a value of angular measure from φ₁ to φ₂

Where, L=length of measuring strip between an angular measure φ₁ to φ₂
t=thickness of the measuring strip (102)

A preferred embodiment of the present invention is configured to display and communicate a linear measurement as measured by the fist measurement manner and which is a direct or a linear measure, wherein between any two linear measurements, a finer resolution detectible by the second measurement manner is used to display and communicate a precise measure up to 0.05 mm. The second measurement manner is thus deployed analogous to a “vernier” scale of commonly known vernier callipers. It is therefore appreciable that the linear measurement device as per present invention is comparable to a vernier calliper, known for their precision!

As a variation, the present invention is provided to display and communicate only with a first measurement manner or only with a second measurement manner.

Measurements by the first measurement manner and the second measurement manner are compared periodically and corrected/calibrated for coarse and fine correction as per application.

The first measurement manner which is the direct manner is also an absolute measurement manner since it is configurable irrespective of a reference point like zero position etc., since a home position is permanently stored. Consequently, in the event of a power failure or interruption followed by resumption the measurement device reads and communicates error-free measurement as each reading is an absolute value, quite like a conventional printed measuring roll, and there is a specific digital signal associated with every position.

In the embodiment with only a second measurement method, a home position is inputted once, for each session of measurement by rolling in the measurement strip completely.

The linear measurement device (100) as per present invention is communication capable. Measurements being carried out are directly radio communicated to a target file as the user presses a button present on the device on completion of each measurement. Such measurements may be stored on the measurement device or communicated in real time, or both.

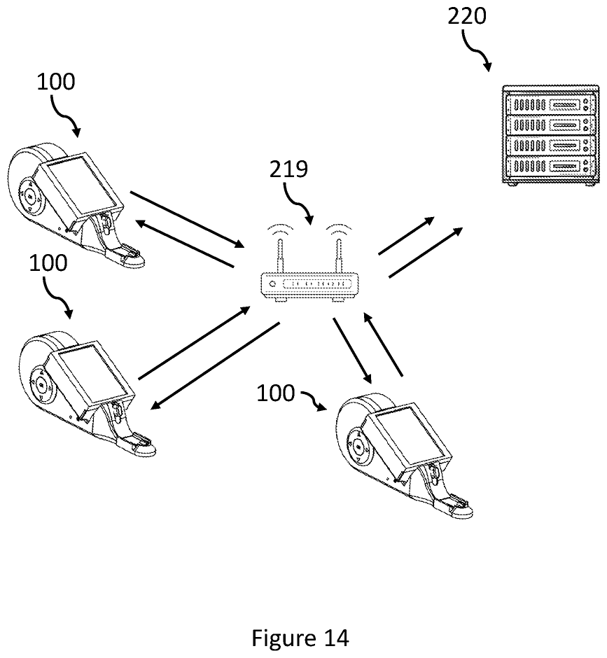

The communicable linear measurement device (100) as per the present invention offers a huge technical advance in bulk measurements particularly in manufacturing and inspection of products with linear measurements. One such application is in garment manufacture, and following description is based on such manufacture. However, the communicable device (100) is not restricted thereto. Products are generally measured against a specification which has multiple points of measure. Product of each size and version has different measurement and different corresponding specification. Products are checked against these specifications at different stages of production. Generally, specification formats are modified as per the stage of production/inspection as convenient to the factory production and quality team. Such changes include but are not limited to a checker identification number, a style name/number, ordering of point of measures for better speed and lower material handling, date, line, error highlighting, final result of pass or fail, statistical quality control parameters like AQL etc. The present invention addresses such needs in a 2-way communication. FIG. 14. The linear measurement device (100) as per present invention is equipped with communication capability from and to a server (220) through a WIFI router (219) or directly through Bluetooth, or through any state-of-the-art communication capability.

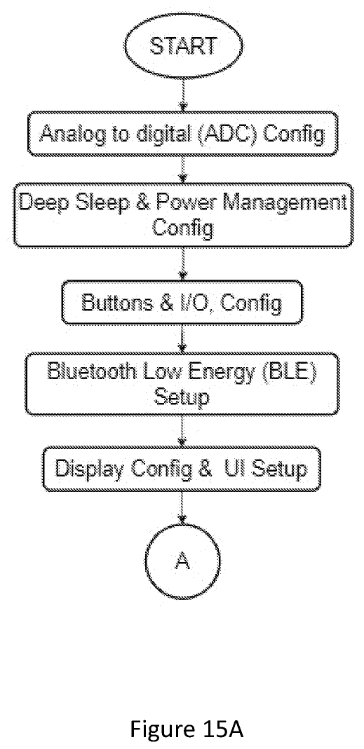

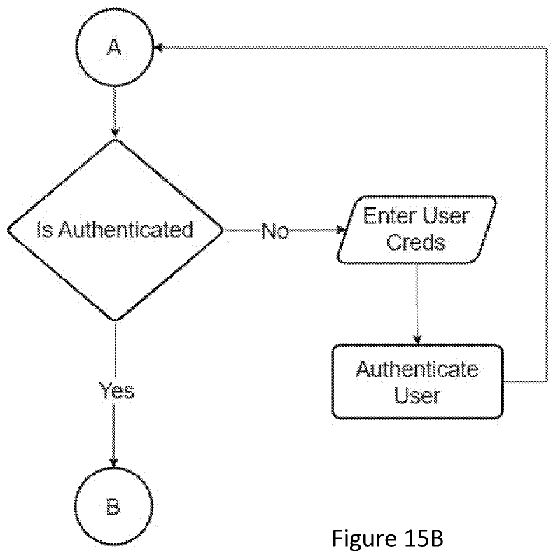

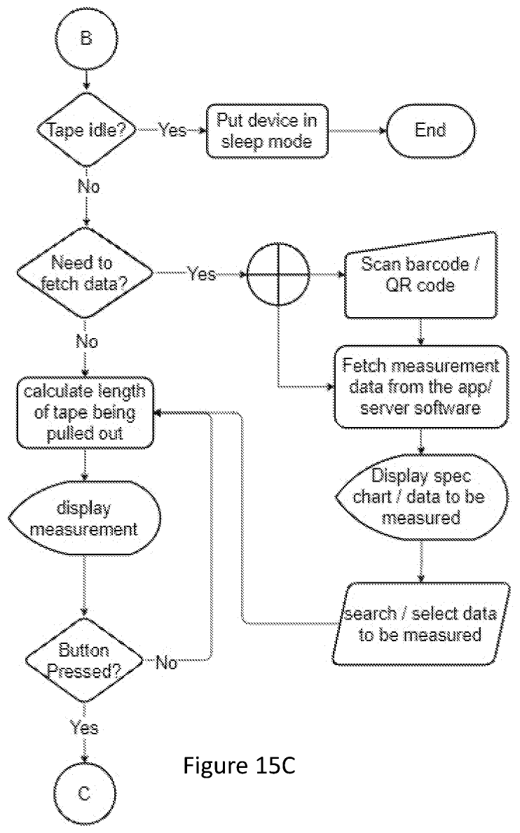

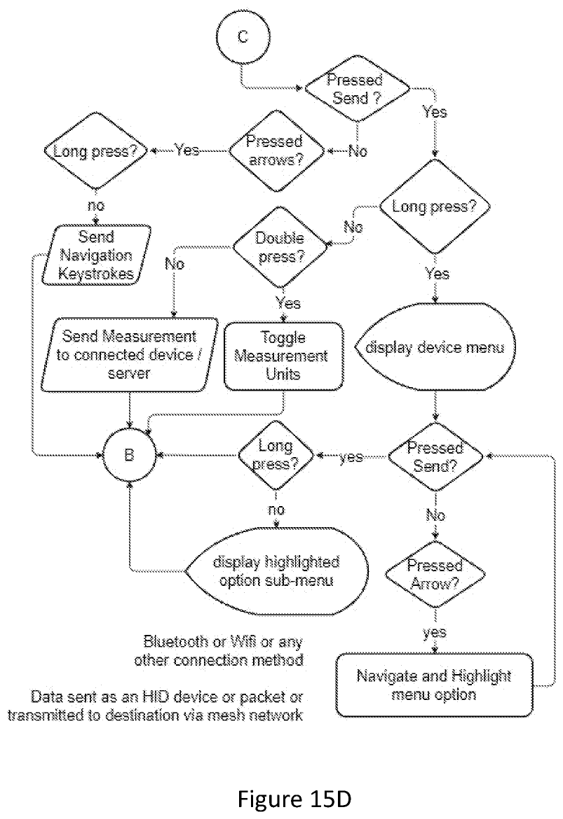

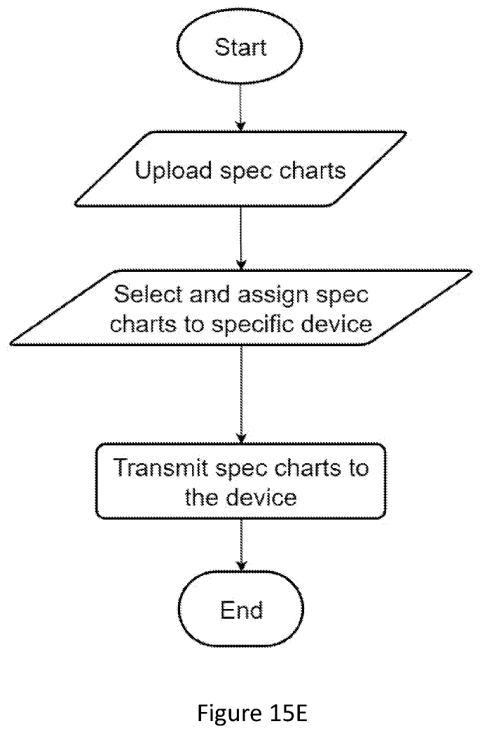

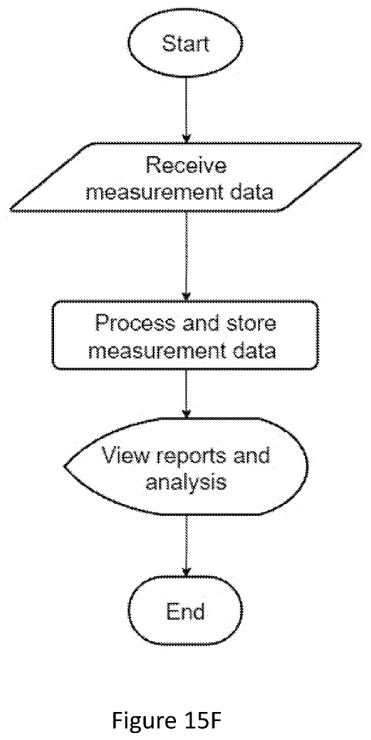

FIG. 15A, the communicable linear measurement device (100) is started or is woken up from deep sleep state by pressing a start button configuration to commence an initialization, whereby the device, in its preferred embodiment, sets up a base code previously resident in a micro-controller in the printed circuit assembly (180), activates configuration files, Bluetooth low energy (BLE) keyboard including button configuration, magnetic sensor configuration; and a user interface is loaded. This makes the device usable communicably.

FIG. 15B-15D, after a user authentication, the device is usable by pressing a measurement button configuration to display or send each measurement. Each measurement is organized and sorted according to a fetched format received and is stored at a prescribed field location in a server (220). In this 2-way communication process, each and every data generated by a linear measurement is an organized data ready for analysis by server (220). Particularly, the linear measurement device (100) receives specification charts/templates from server (220), FIG. 15E, and the server (220) receives measurement data in apposition, FIG. 15F.

A connected server (220) can send data/instructions/suggestions to the measurement device (100). The measurement devices (100) can also send data/instructions/suggestions to the server (220). This innocent looking 2-way communication in between device and server (220) and this functionality is used to capture, implement and achieve many process improvements, which otherwise get lost in manufacturing routines.

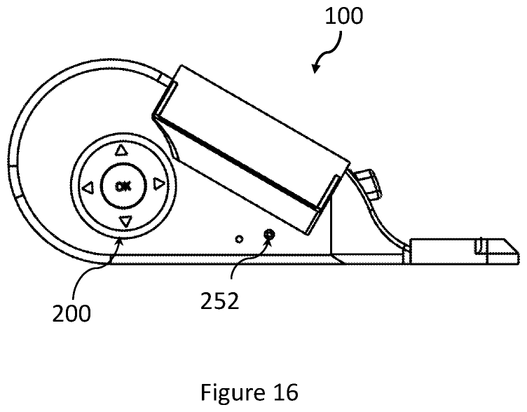

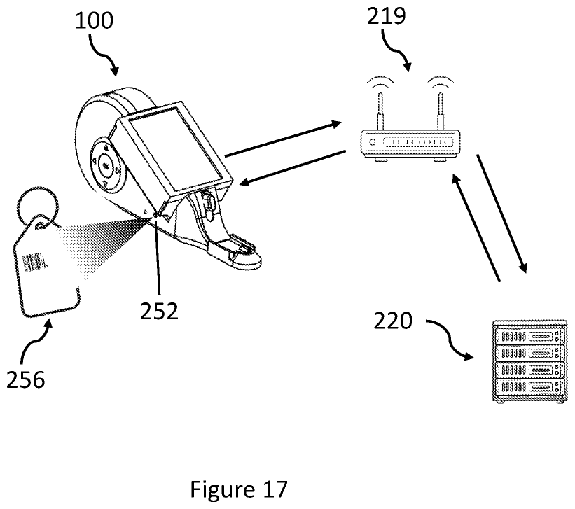

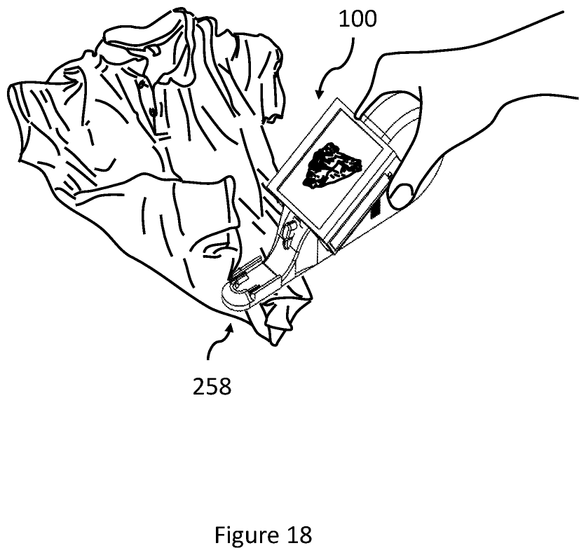

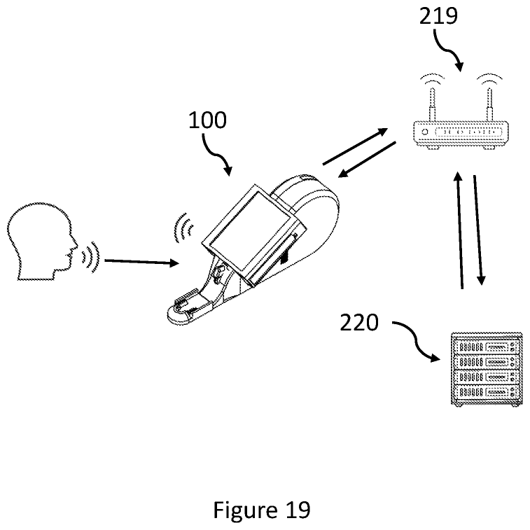

The 2-way communication in the present invention is not limited to sending and receiving text only. FIGS. 16, 17, a camera (252) provided in the device (100) facilitates scanning a code (256) including a QR code, a bar code, to fetch a corresponding specification. FIG. 18, the camera (252) facilitates visual capturing, recording and communicating of a defect (258) or anomaly. The 2-way communication includes a voice to text communication to server (220) and a text to voice communication to the device, through a microphone and a speaker (not shown) disposed on the back of the printed circuit assembly (180) of the device (100). FIG. 19.

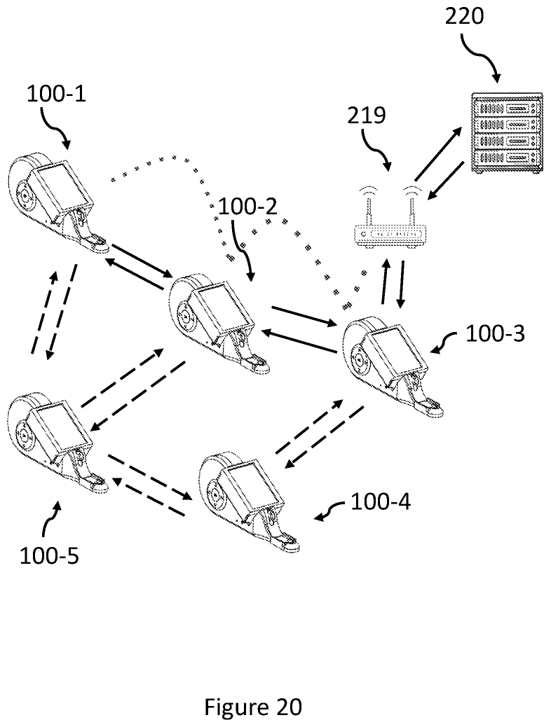

FIG. 20, in a manufacturing ambience, there are generally multiple measuring devices (100-1, 100-2, 100-3, 100-4, 100-5) present. Not all the devices may by present in an adequately strong connectivity signal at all times, due to distance from WIFI routers (219), obstructions and or user moving around, resulting in one or more devices intermittently or repeatedly transitioned into an offline mode. The present invention addresses such common industrial situation in an inventive and redundant way.

The communicable device (100) buffers a measurement data in low or no connectivity instance and send/receive continues seamlessly as the network connectivity restores. The device auto shuts when it nears end of power to a prescribed low level.

Importantly, each device is equipped with a routing functionality and presence of any other device (100) is effectively equivalent to a router (219) in vicinity. In other words, in a factory ambience with a dense population of the communicable device (100), a burden on router placement significantly reduces while a robust data management seamlessly and silently delivers required data and specification. A group mesh formation of devices as shown in FIG. 20 is with a device identification number associated with each data string. The mesh formation reduces network investment wherein data including specification hops from one device to the other or directly to the router and a combination thereof, while at the same time the data remains clearly identified and segregated specific to identification provided. A plurality of measuring devices (100-1, 100-2, 100-3, 100-4, 100-5) within a prescribed distance can send or receive data and attach an address. Addition of a device is configured only at the server level and the server (220) communicates device identification to all the devices in an identified group. The group mesh formation of devices provides insulation between different group mesh formations, which is a practical reality causing nuisance of data leakage in a cramped manufacturing complex of different firms.

Deployment of routing functionality in each measurement device (100) is yet unexplored in industrial ambience of mass manufacture, particularly in a non-continuous line of manufacture which the present invention effectively does which minimises data loss and opens avenues of building artificial intelligence around such organized data, collectible with minimal efforts.

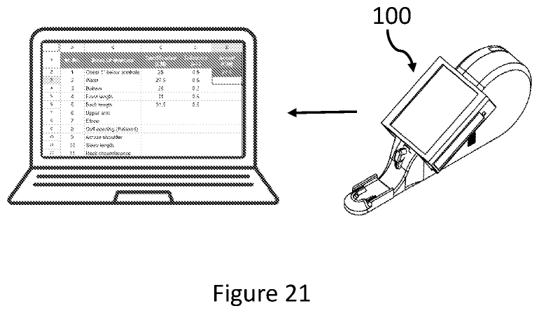

FIG. 21, the communicable linear measurement device (100) is configurable to operate independent of the server software in an “individual” mode, wherein the device is either paired with a laptop/mobile or used without pairing. In the preferred embodiment, the device is discoverable on laptops/mobiles as a Bluetooth device. Once the connection is established by clicking on the pair/connect option, the device (100) works like a Bluetooth keyboard, wherein the data sent by the device is sent to an active application on the laptop screen, like any connected keyboard would send. The active application could be any contemporary application including excel/other spreadsheet, text file or any custom QM/PLM software. Illustratively, the data sent by the device configured as “individual” is captured in Excel sheet at a pre-decided location/field. Further, the user has an option to use the navigation buttons (200) disposed on the device for navigating in the paired excel sheet/spreadsheet.

Such networked two-way communication capability creates possibilities to manage the growing complex and interdependent communication in between the device and the server (220), consequent to the new opportunities of analyses and deployment created by the present invention, as unlimitedly multiple such independent communications would possibly be happening simultaneously for all devices together.

Further, this data is now available in real time and analyses of this data would be obtainable in real time. This arrangement could lead to further foreseeable actions by the server like blocking a device or sending warning signals to devices etc. Parallelly this analysis enables the managers related to the factory shop floor to take quick action anywhere anytime which could result into huge reduction in cost of poor quality by nipping the problem in the bud itself.

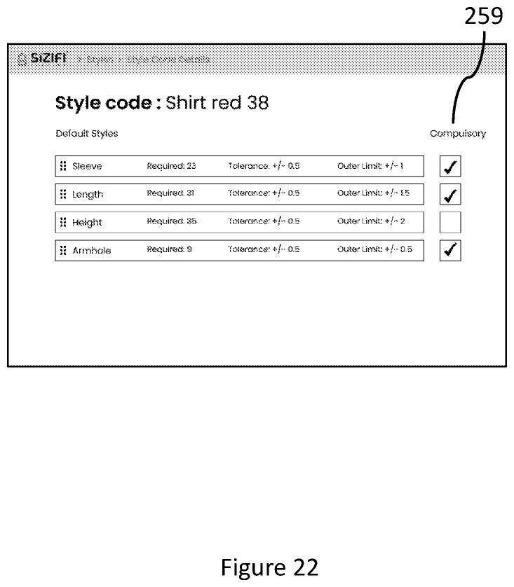

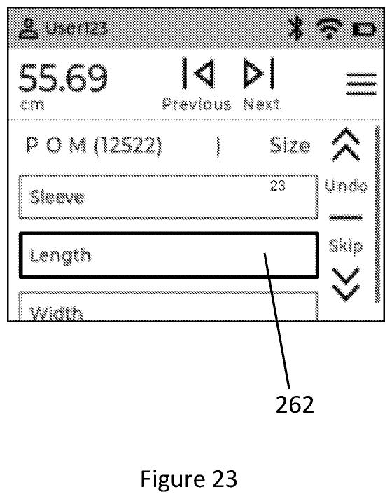

To strike a balance between quality and productivity, a number of supervisory configurable controls are incorporated. Illustratively, a supervisory configurable control permits a measurement to be skipped if it is not tagged as compulsory (259), FIG. 22. Or a measurement is permitted to be taken at a prescribed frequency, like hourly, or after a prescribed number of measures, or for a prescribed number of measures. On the other hand, a compulsory measure cannot be skipped by a user. If there are any compulsory measurements and have not yet been recorded, the system does not allow to go to the next garment, instead showing the unskippable measurements as highlighted (262) which are still blank, FIG. 23.

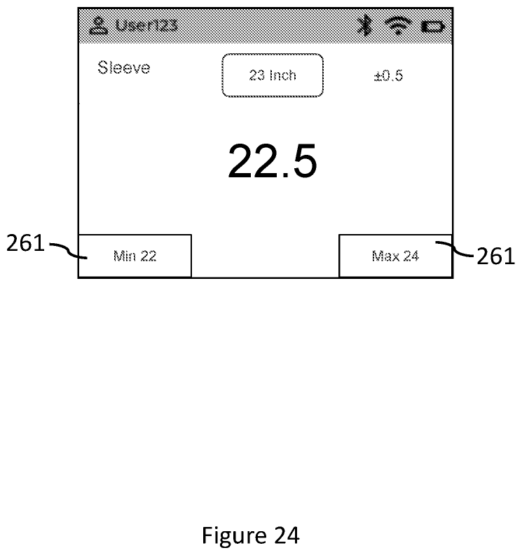

A dimensional tolerance (261) is relaxable by a supervisory configurable control. A previously prescribed dimensional tolerance (261) is displayed on the measurement device for respective measurement, FIG. 24. If a reading taken is out of prescribed tolerance band, the measurement device (100) prompts to confirm or retake the measurement. If the user confirms, it may imply that the particular object to be segregated.

The supervisory configurable controls are exercised through a server software and or through a supervisory measurement device, which in turn is such authorized through the server software. The supervisory configurable control is dynamically controllable to be effective cyclically or at a set time or device wise, as assessed by the manager and or as per the need on the shop floor.

The measurement device as per present invention has a plurality of navigation buttons (200) and a display (155) as a user interface with the computer program residing in the measurement device (100).

The measurement device (100) as per present invention may be equipped with a laser line to facilitate precise references of measurement when used for conventional or manual measurement activities.

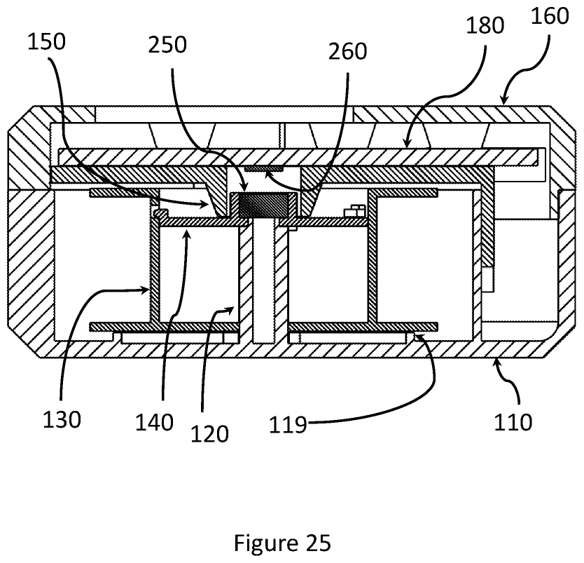

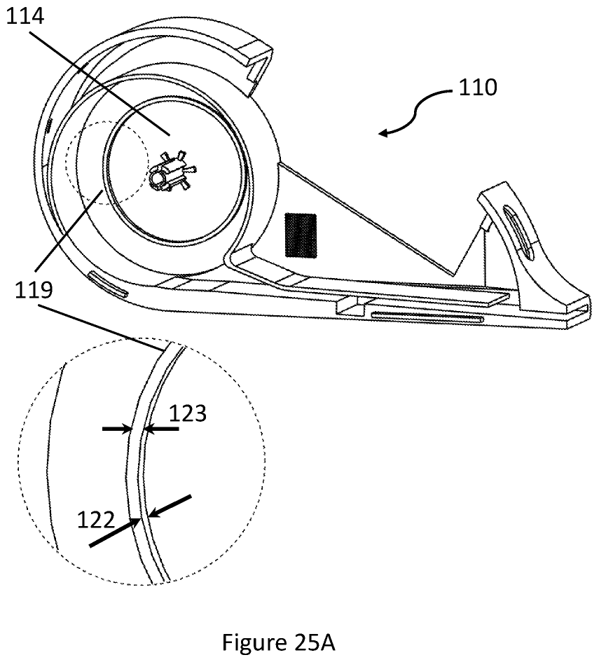

The measurement device (100) may be calibrated by the computer program residing in the measurement device. The measurement device (100) may be manually calibrated as well To effectively harness the precision obtainable as per the concept of redundant measurement, it is important that the design is immune to mechanical variations including assembly and manufacturing variations. FIGS. 25 to 34 address this important aspect of the present invention.

FIG. 25, the measurement device (100) as per the present invention is prudently organized in and around casing (110) for all mechanical components. FIG. 25A, the casing (110) comprises an integrated bobbin shaft (120), manufactured and produced by injection molding. Consequently, the bobbin shaft (120) is orthogonal to a base (114) of the casing (110) with the precision of machining of the injection mold which is of the order of thousandth of a millimeter. The casing (110) has a rim (119) of a low height collar (122) of typically less than a millimeter and a low width (123) of less than a millimeter. The rim (119) ensures a minimum frictional forces comes into play when the bobbin (130) rotates. In absence of such a rim (119) an entire circular surface would be rubbing against the base of the casing (110) causing excessive frictional force to be then countered by a spring of relatively higher force, thus lesser life!

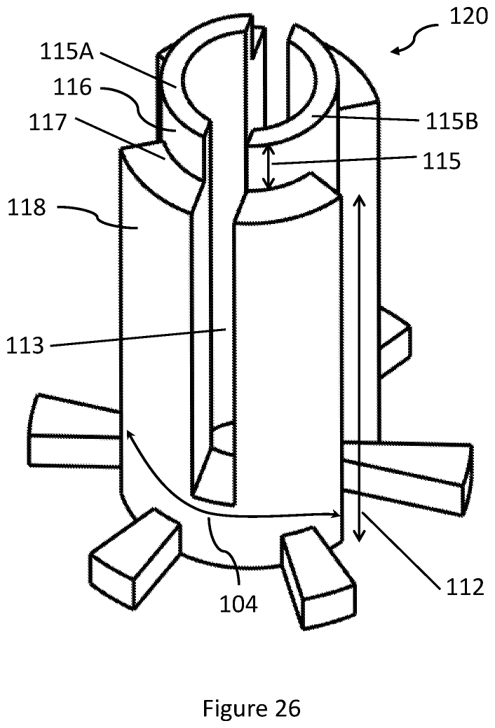

FIG. 26, the bobbin shaft (120) is a hollow, comprising a minimum diameter cylinder (116) and a maximum diameter cylinder (118) for a restricted circumference (104) and a restricted height (112), consequently resulting into a stepped cylinder (115) and a plurality of seats (117). A slit (113) divides the bobbin shaft (120) into two halves, while the stepped cylinder (115) also is bifurcated into two halves (115A, 115B), which reversibly collapse inwards on application of an external inward force F on both sides.

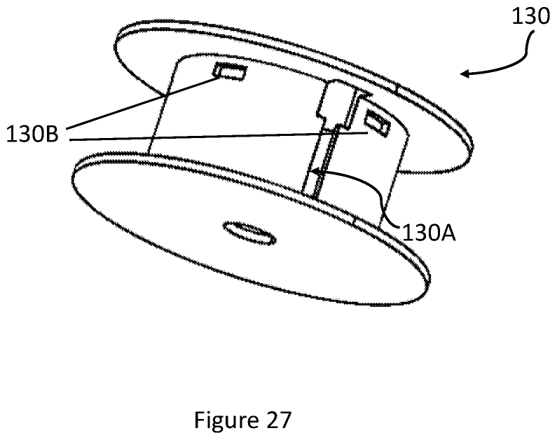

FIG. 27, a bobbin (130) houses a torsion coil spring (125) in an inside and wraps a measuring strip (102) on an outside, has a bobbin slot (130A), and a mounting provision for disposing a magnet holder (140) which also acts as a spring cover. The mounting provision could be a plurality of recesses (130B).

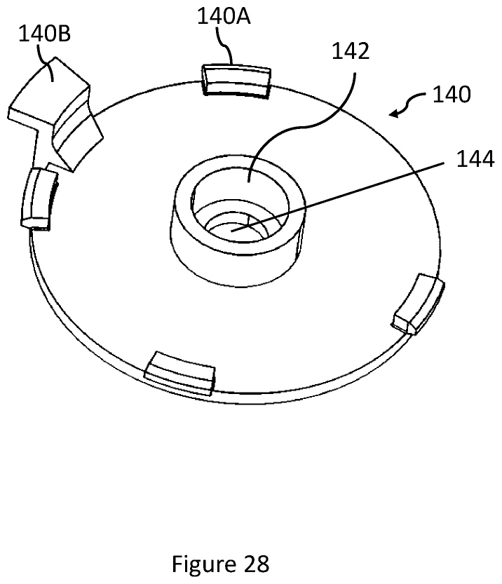

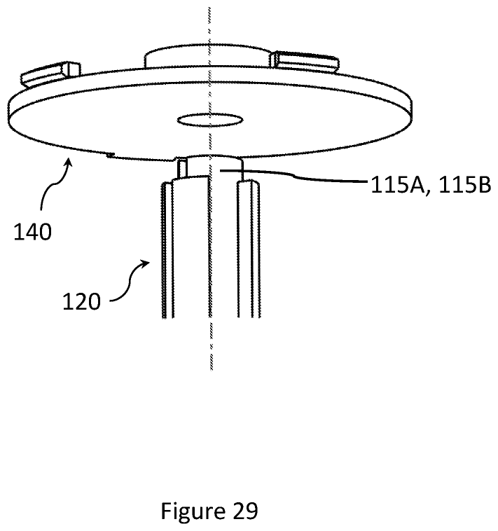

FIG. 28, the magnet holder (140) has a plurality of mounting projections (140A) corresponding to the plurality of recesses (130B) in the bobbin (130), a stepped hollow cylinder wherein a large inner hollow cylinder (142) houses the slim diametric magnet (250) which is interference fit, while a small inner hollow cylinder (144) interferingly captures the two halves (115A, 115B) of the stepped cylinder (115), FIG. 29, while the magnet holder (140) is pressed into its mounting provision in the bobbin (130), resulting into the inward force F on the two halves (115A, 115B) of the stepped cylinder (115). Simultaneously the magnet holder (140) also rests on the seat (117) of the bobbin shaft (120). Such a construction minimizes axial play (up-down) and angular wobble.

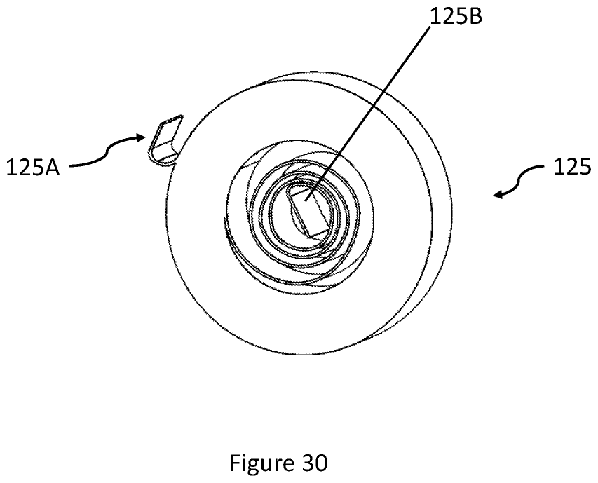

FIG. 30, The torsion coil spring (125) has an outer end (125B), which is engaged in a bobbin slot (130A), while and inner end (125A) is trapped in the slit (113) of the bobbin shaft (120).

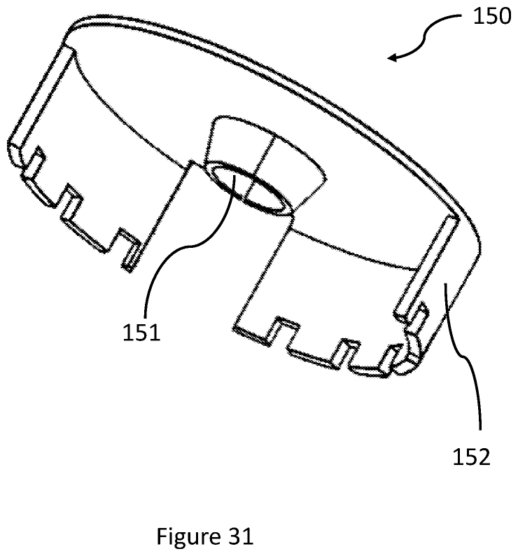

FIG. 31, a stabilizer (150) having a collar (151) and a fence (152) is disposed between a printed circuit assembly (180) and the bobbin (130) which is particularly holding the diametric magnet (250) having a conducting surface, the stabilizer (150) functioning as a mechanical compacter and an electrical insulator. The collar (151) engulfs the stepped hollow cylinder of the magnet holder (140), while pressing the magnet holder (140), further pre emptying possibility of wobble.

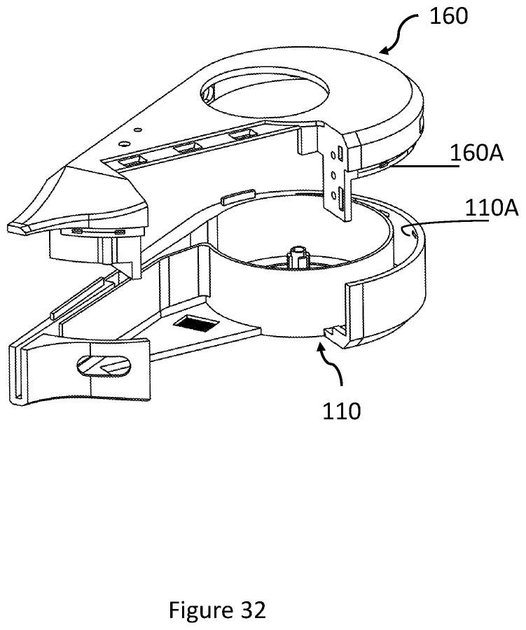

FIG. 32, a device cover (160) with a plurality of peripheral projections (160A) fits onto a complementary plurality of peripheral receptacles (110A) of the casing (110). The peripheral projections would not reach/engage with the complementary peripheral receptacles if there is any undue gap between the printed circuit assembly (180) and the stabilizer (150).

As a variation, the device cover (160) could be with a plurality of peripheral receptacles (110A) that capture a complementary plurality of peripheral projections of the casing (110). The reverse arrangement would likewise engage if there is any undue gap between the printed circuit assembly (180) and the stabilizer (150).

The projections and the corresponding receptacle are combinations of equal or unequal dimension and shape's different peripheral locations on casing and device cover (160).

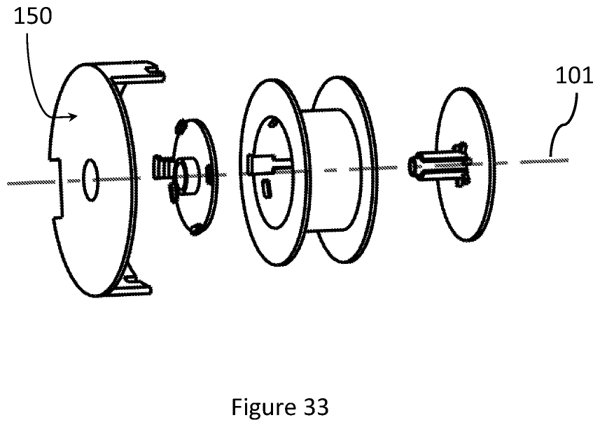

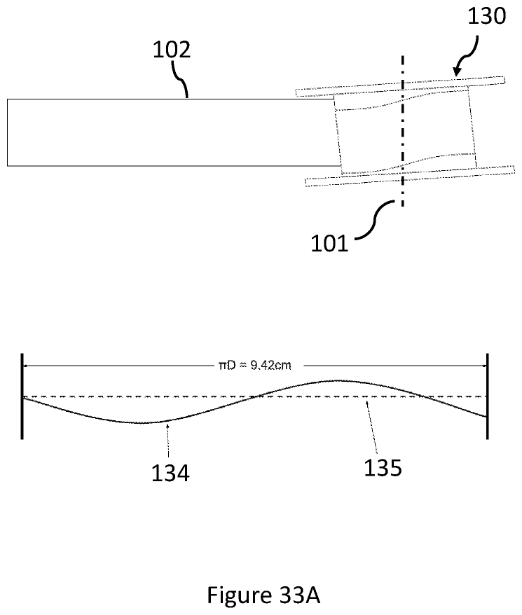

FIG. 33, such an assembly with the stabilizer (150) has an engineered constraint in the axial direction of the axis (101) to ensure minimal operational play axially as well as angularly around a root of the bobbin shaft (120). A consciously reduced surface contact between the casing (110) and a bottom surface of the bobbin via the rim (119), between the bobbin shaft (120) and casing (110) on a lower side, and between the bobbin shaft (120) and the magnet holder (140) on an upper side ensures minimal operation friction, thus rolling/unrolling force and wear.

FIG. 33A, a wobble of the bobbin (130) may apparently measure an excessive measure (134) as shown by a solid line for a corresponding true length (135) as shown by a dotted line. In the present invention, importantly, the first measurement manner which is the linear measurement (103) of the unrolled segment of the measuring strip (102), is immune to a wobble of the bobbin since an 8-bit optical encoding provides a wobble-independent measure at every 0.6 cm (150 cm/2\hat{ }8), Consequently, a wobble is restricted to cause error in between these intervals ONLY as after every optical reading the previous error is reset and prevented from accumulating. Within this interval of 0.6 cm, the angular measurement of the un-rolled segment of the measuring strip (102) gives a resolution of 0.005 cm. Even at an error of 10%, which is highly unlikely given the engineering constraint as explained above, this will 0.0005×0.6=0.0003 cm error, which also is predictable and adjusted in calibration mode.

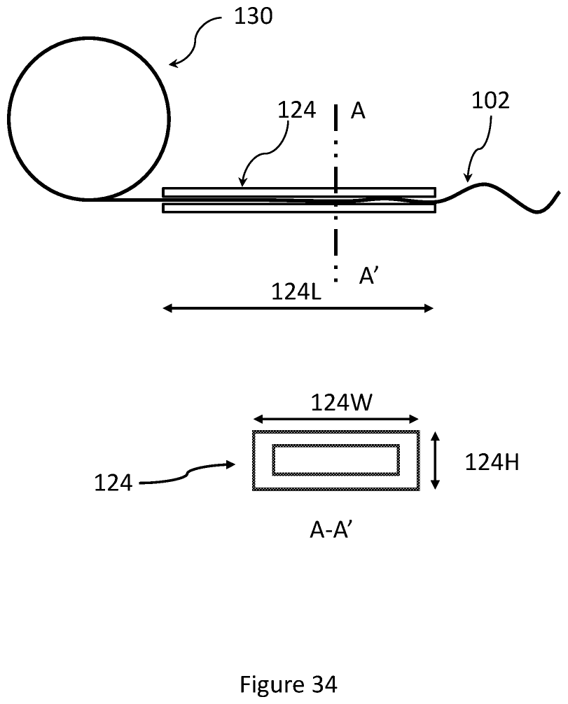

FIG. 34, a slender passage (124) is created in the casing (110) having a width (124W) and a height (124H) marginally higher than the width and the height of the measuring strip (102), with a relatively much longer length (124L), of the order of 2 cm to 6 cm or more. The slender passage (124) arrests wavy strip entering the slender passage (124) due to a force of the torsion coil spring (125) which constantly keeps the measuring strip under a tendency to be pulled and rolled on the bobbin. Arresting the waviness by letting them “die” in the slender passage (124) is a prudent and inventive aspect of controlling undesired air from entering while the measuring strip (102) is allowed to roll back freely, and consequently checking and controlling unnecessary air getting trapped in-between different layers of rolled strip and avoid error due to diametric variation in magnetic measurement.

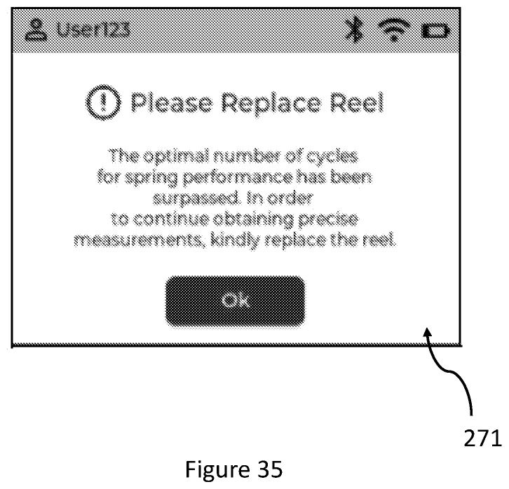

Another source of inter-layer air gap related variation is aging due to use and consequent reduction in pull force of the aged spring. As per the present invention, once a predefined number of cycles of rolling and unrolling of measuring strip (102) are counted by the computer program, the device displays and suggests to replace (271) a measuring strip assembly (170). FIG. 35.

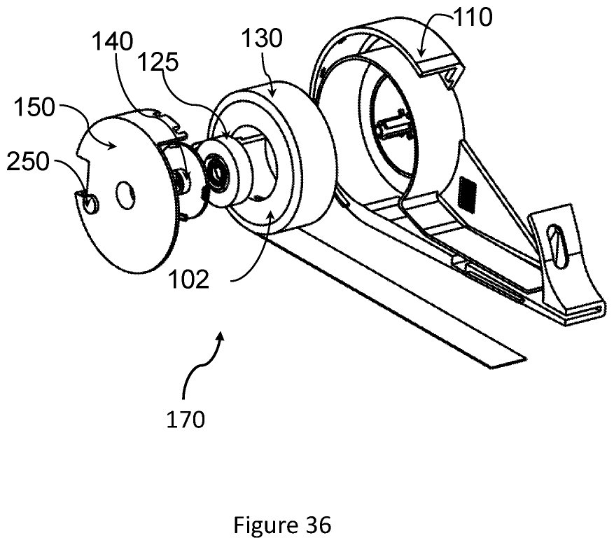

The present invention is conducive to such a replacement by user, wherein the measuring strip assembly (170) comprises a casing (110) housing the bobbin (130) with the magnet holder (140), torsion coil spring (125), diametric magnet (250), stabilizer (150) and the measuring strip (102). FIG. 36.

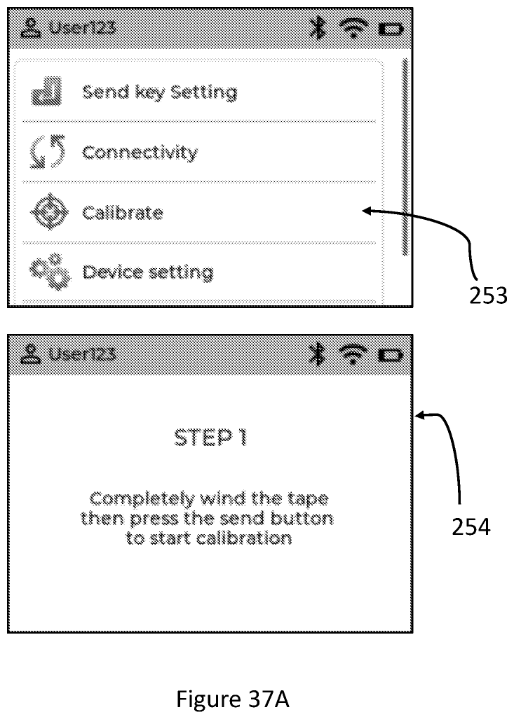

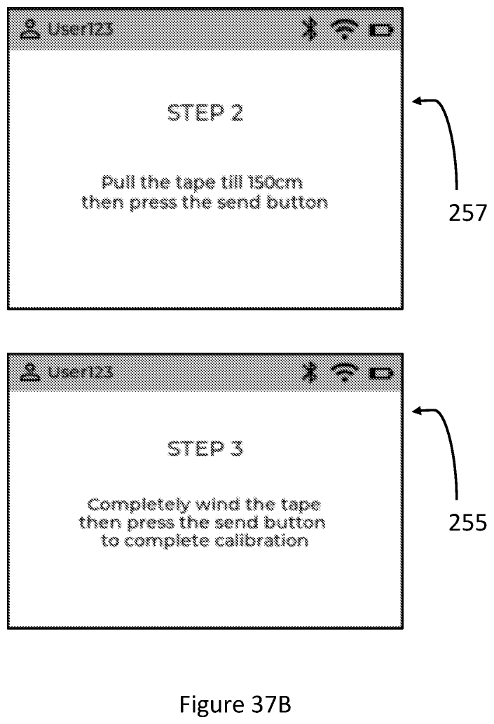

The measurement device (100) is calibrate-able. FIG. 37A, a user selects calibration (253). Step 1 (254) displays “completely wind the tape, then press send button to start calibration”. FIG. 37B, Step 2 (257) displays “pull the tape till 150 cm then press the start button”. Step 3 (255) displays “fully wind the tape, then press send button to complete calibration.

The measurement device (100) as per the present invention performs an inbuilt automatic calibration at regular intervals based on a pre-set count of winding/unwinding cycles, prudently exploiting the inventive dual encoding feature of the present invention.

Such automatic self-calibration is directly relatable to predictable as well as unpredictable wear and tear and the correction consequently necessitated. Particularly, a variation in an effective thickness (implying a material thickness and an inter-turn gap) and length of the measuring strip with reference to a prescribed corresponding initial value consequent to use, aging and or environmental effect and with reference to a relatively non-wearing references including a base diameter of the bobbin on which the measuring tape commences rolling is calculated in accordance with the first measure and the second measure statistics generated in the linear measurement device (100) and compensated depending on application. The automatic self-calibration assumes significance particularly if a defect like unusual variation in effective thickness due to contamination, or a tear or a fragmentation of the measuring strip happens, which otherwise would impact quality of measurement between two widely instances of planned calibrations!

The measurement device (100) as per the present invention is prudently organized in and around casing (110) for all mechanical components, and in and around the cover (160) for all electrical & electronic components. This inventive segregation facilitates short length of pluggable connections, mutually as well as exclusively enhances precision AS WELL AS robustness of the device (100).

The printed circuit assembly (180) is disposed in the device cover (160) and all associated electrical parts are correspondingly laid out, as described below. A camera (252), previously described, is disposed on a back of the of the printed circuit assembly (180), peeps out of an opening provided in the cover (160).

A versatile 5-button navigation keypad (200) sits on an outside of the cover (160) through a keypad slot provided. The keypad is disposed on the back of the printed circuit board (180) and projects out of the cover (160) at an agronomical location particularly for a right hand person, aiding to quick actions and productivity, see FIGS. 18, 16.

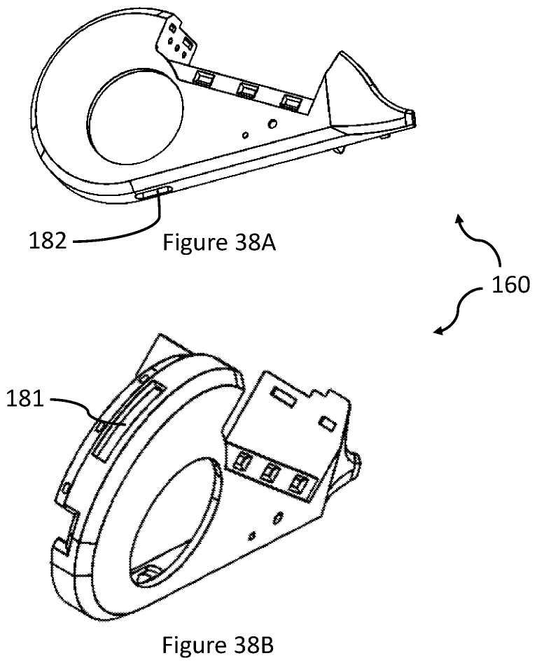

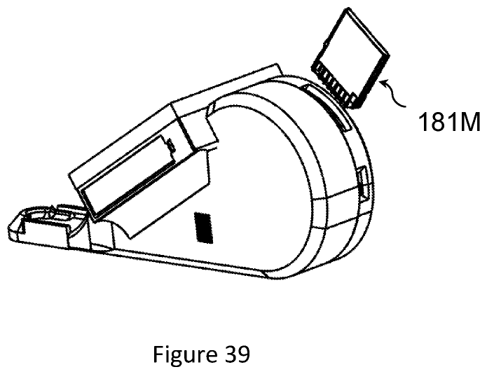

FIGS. 38A, 38B, a memory card receptacle (181) is provided through which a contemporary external memory card (181M) is insertable, FIG. 39, such that the external memory card (181M) connects to the printed circuit assembly (180) directly. The external memory card (181M) stores measurement data during unscheduled or temporary disconnections with the server. Also, in case of the measurement device (100) being used in an offline mode, all measurement data is stored in this external memory card (181M) only.

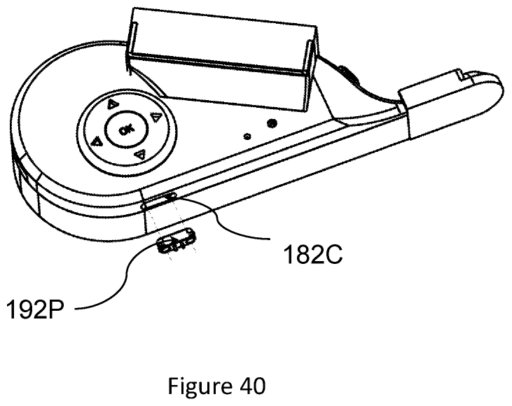

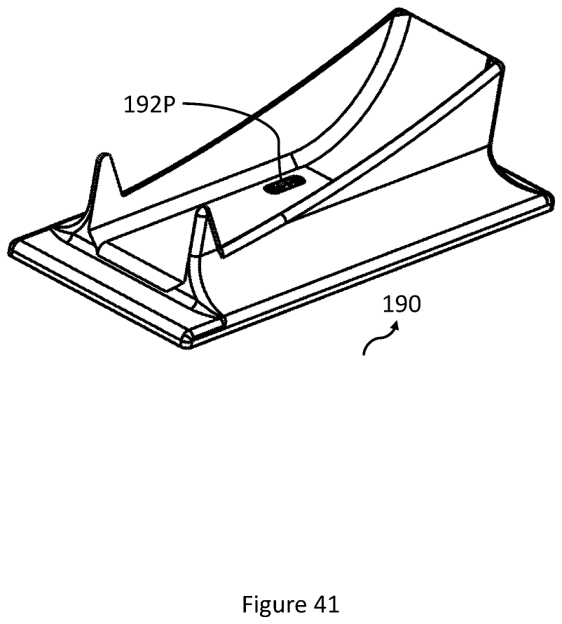

A charging receptacle (182) is provided in the cover (160), through which a charging pad (182C) pops out of the measuring device (100), FIG. 40, to be able to mate with a charging pin (192P) correspondingly disposed in a complementing charging dock (190). FIG. 41.

The cover (160) of measurement device (100) has a USB port receptacle through which a USB port disposed on the printed circuit assembly (180) is accessible to upload and download data, besides charging.

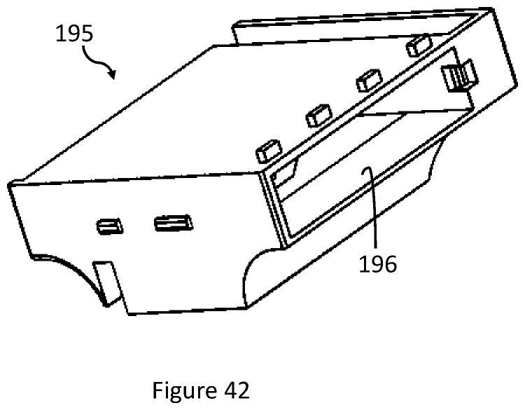

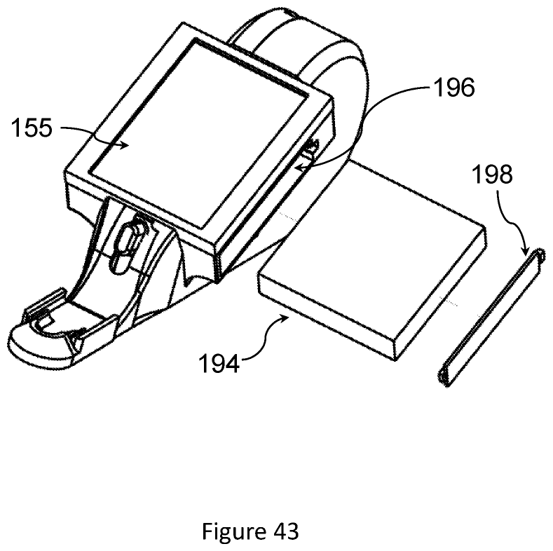

FIG. 42, a display cum battery receptacle (195) is disposed on the cover (160). The display cum battery receptacle (195) receives a 1000 mAh to 2000 mAhr battery (194), FIG. 43, in a socket (196). A battery cover (198) plugs into an opening of the receptacle (195). A display panel (155) is disposed on a top face (197) of the receptacle (195). Connecting wires from the battery as well as the display panel (155) are routed to the printed circuit assembly (180) through a plurality of guides provided in the display cum battery receptacle (195). The battery capacity is primarily limited by size of batteries and not necessarily by parts and components of the electronic circuitry.

The measurement device (100) as per the present invention, consequent to being provided with a 2-way communicable capability can cater to newer industrial needs, without ignoring conventional needs. Many times, situations arise when some ad hoc inspection is required to be done, but no specification chart for inspections is available. With our 2-way communication enabled device this becomes like any other regular inspection. There is an option to start an ad-hoc inspection and this could be initiated in a blank document where the format is built as the user starts creating and measuring points of measure. Or this could be started in a pre-built template which is like a skeleton format of the most common points of measure specific to a certain type of designs like shirts, trousers, blouses etc. This is categorised under user defined styles in the server in folder configuration. Different styles are like different folders under the broad category of user defined Styles.

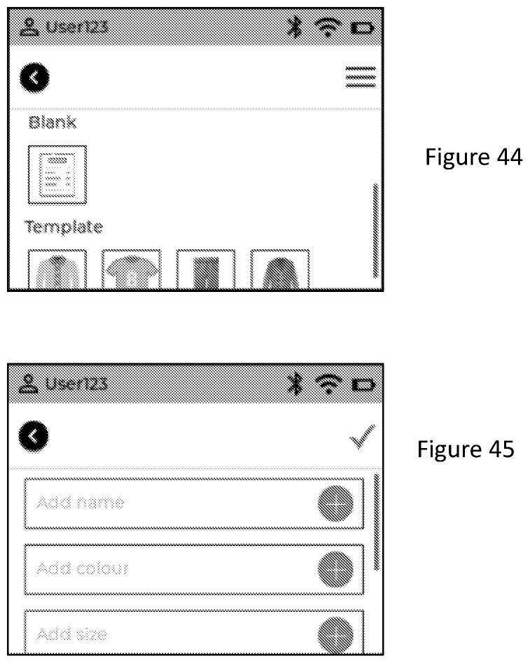

This process possibilities are unlimited and can be understood from some of the non-exhaustive illustrative display screens, FIGS. 44-50.

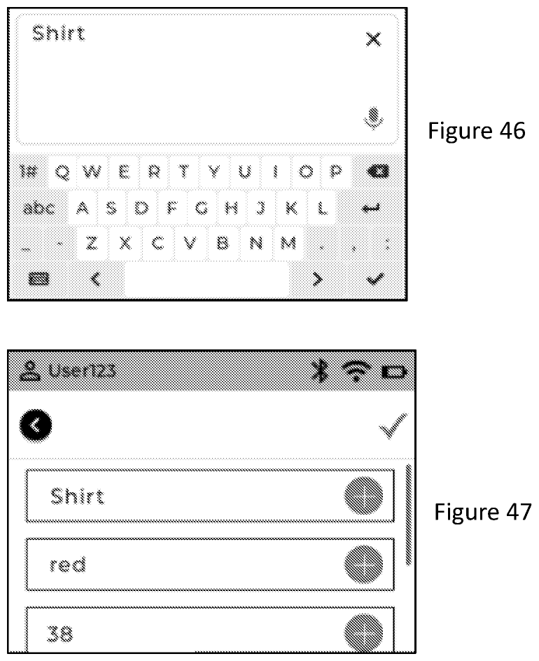

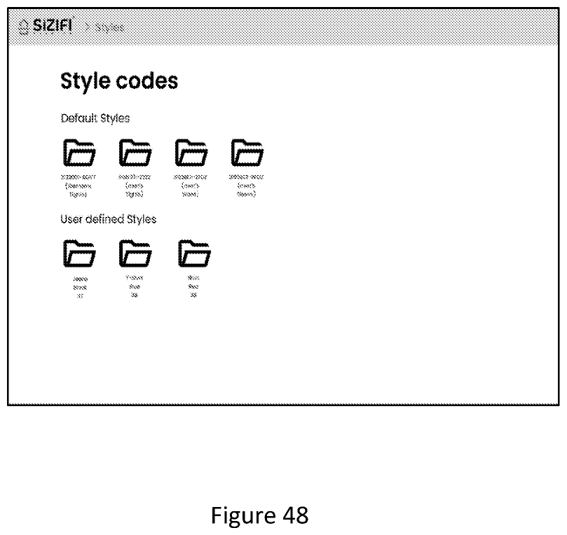

FIG. 44, user opts to either start a blank document or to choose form an existing list of templates. FIG. 45, Based on user selection, the next prompt is to put the base data for the style under name, colour and size fields. FIG. 46, All three fields, once tapped into, result in the text entry format screen with qwerty keypad as well as voice option. FIG. 47, once the data is filled in all the fields, they appear as above and then user can click on the tick mark displayed in green to proceed to the next step. FIG. 48, a new folder is created on the server under user defined styles, titled “Shirt Red 38” (221).

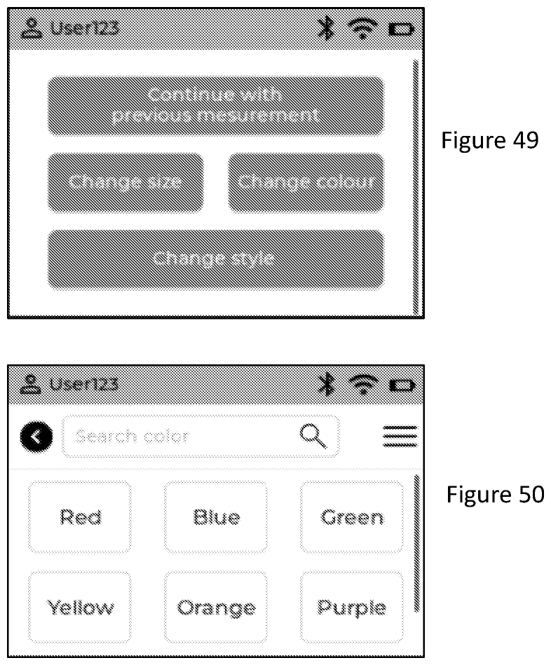

FIG. 49, the user is prompted to continue or change style, size or color. FIG. 50, options of available color prompted.

The present invention of linear measurement device (100), which may appear an improvised “measuring tape” at the first instance, is actually a huge technical advance of intelligently exploiting the mundane data to an organized one. The present invention is an ergonomic and improvised system of devices functioning dependently to meet the objective of economic significance of productivity improvement, quality upgradation, thereby reducing product waste and cost.

1. A linear measurement device (100) comprising a casing (110) and a device cover (160), housing a measuring strip (102) having a conventional measurement markings on a front side (106), the measuring strip (102) rolled on a bobbin (130) containing a pre-stressed torsion coil spring (125), the linear measurement device (100) characterized by:
a printed circuit assembly (180) having a plurality of navigation buttons (200), a display (155), a computer program residing in a micro-controller, the printed circuit assembly (180) disposed in the device cover (160) with the plurality of navigation buttons (200) and the display (155) projecting on an outside of the device cover (160),
the casing (110) having an integrated bobbin shaft (120) and a rim (119), the casing (110) and the device cover (160) engaged with a stabilizer (150) sandwiched in-between,
the measuring strip (102) provided with a markers (105) on a rear side (108) while a detecting means (107) stationed in a referenced position in the casing (110) facing the rear side (108) of the measuring strip (102),
the linear measuring device (100) measures a linear dimension in a first measurement manner and in a second measurement manner,
wherein,
the first measurement manner is a linear measurement (103) of an-unrolled segment of the measuring strip (102), the markers (105) and the detecting means is a magnetic, optical, electric and or a combination thereof,
the second measurement means is an angular measurement (204) of a rolled segment of the measuring strip (102), carried out by a magnetic encoder, an optical encoder, an electrical encoder and or by a combination thereof,
the linear measurement device (100) is configured to display and communicate a linear measure by the fist measurement manner between any two markers and an angular measure by the second measurement manner between every two markers, in an increasing as well as a decreasing value of measure, and
the linear measurement device (100) is configured for a 2-way communication with a server (220).

2. The linear measurement device (100) as claimed in claim 1, wherein the markers for the first measurement manner comprise a continuous linear grid pattern (109) consisting of a plurality of rows of dark zones and or clear zones which are repeatedly printed on the rear side (108) of the measuring strip (102) in the direction of unrolling.

3. The linear measurement device (100) as claimed in claim 1, wherein the detecting means (107) is an 8-bit photodetector (210), configured to send and receive an orthogonally linear beam of light (211).

4. (canceled)

5. The linear measurement device (100) as claimed in claim 1, wherein the magnetic encoder is a rotary encoder that senses a change in magnetic field of a rotating magnetised bar, wheel or ring including a diametric magnet (250), wherein the rotary encoder is a plurality of hall effect sensors (260) detecting a rotation of the diametric magnet (250).

6. (canceled)

7. (canceled)

8. The linear measurement device (100) as claimed in claim 1, wherein the 2-way communication is via one of a WIFI or a Bluetooth signal with a server (220).

9. The linear measurement device (100) as claimed in claim 1, wherein the linear measurement device (100) is configured as an offline device, wherein the linear measurement device (100) is either paired with a laptop/mobile or used without pairing.

10. The linear measurement device (100) as claimed in claim 1, wherein the linear measurement device (100) is configured to fetch a specification template from the server (220).

11. The linear measurement device (100) as claimed in claim 1, wherein the linear measurement device (100) is configured to generate a specification template.

12. The linear measurement device (100) as claimed in claim 1, wherein the linear measurement devices (100) when present in plurality form a 2-way communication amongst themselves for sending data to and receiving data from the server (220).

13. The linear measurement device (100) as claimed in claim 12, wherein the 2-way communication is configured to be insulated from and to an unidentified linear measurement device (100) in the vicinity.

14. The linear measurement device (100) as claimed in claim 1, wherein the 2-way communication sends and receives data, text, an image, a code and or an audio.

15. The linear measurement device (100) as claimed in claim 1, wherein the linear measurement device (100) is configured with a supervisory configurable controls including skipping a measurement from a specification, altering an acceptable tolerance from a specification.

16. (canceled)

17. (canceled)

18. The linear measurement device (100) as claimed in claim 1, wherein the linear measurement device (100) is calibrated by keying in a home position and a prescribed measure.

1. 19. (cancelled)

20. (canceled)

21. The linear measurement device (100) as claimed in claim 1, wherein the linear measurement device (100) comprises a replaceable measuring strip assembly (170) comprising a casing (110) housing the bobbin (130) with the magnet holder (140), the torsion coil spring (125), the diametric magnet (250), the measuring strip (102), and the stabilizer (150).

22. The linear measurement device (100) as claimed in claim 21, wherein the replaceable measuring strip assembly (170) is replaced after a predefined number of cycles of rolling and unrolling of measuring strip are counted by the computer program and the device (100) prompts to replace the measuring strip assembly (170).

23. (canceled)

24. (canceled)

25. (canceled)

26. (canceled)

27. (canceled)

28. (canceled)

29. The linear measurement device (100) as claimed in claim 1, wherein the device cover (160) has a USB port receptacle through which a USB port disposed on the printed circuit assembly (180) is accessible to upload and download data, besides charging.

30. The linear measurement device (100) as claimed in claim 1, wherein the device cover (160) has a display cum battery receptacle (195) that receives one of a rechargable and a non-rechargable battery (194) in a socket (196), a battery cover (198) plugs into an opening of the receptacle (195), a display panel (155) is disposed on a top face (197) of the receptacle (195), connecting wires from the battery as well as the display panel (155) routed to the printed circuit assembly (180) through a plurality of guides provided in the display cum battery receptacle (195).

31. The linear measurement device (100) as claimed in claim 1, wherein the computer program residing in the micro-controller of printed circuit assembly (180) executes the 2-way communication between the linear measurement device (100) and the server (220), between a plurality of linear measurement devices (100-1, 100-2, 100-5 3), enables a configuration of the linear measurement device (100), in an online and an offline mode.

32. The linear measurement device (100) as claimed in claim 1, wherein each measurement device (100) is equipped with a routing functionality.

33. (canceled)

34. The linear measurement device (100) as claimed in claim 32, wherein the group mesh formation including addition and or deletion of a measurement device (100) is a supervisory configurable control, by which the server (220) communicates a device identification to the identified measurement devices (100).

35. (canceled)
